(19) United States
(12) Patent Application Publication
(10) Pub. No.: US 2023/0086610 A1
(43) Pub. Date: Mar. 23, 2023

(54) CURABLE SILICONE-ACRYLATE COMPOSITIONS, CONDUCTIVE MATERIALS PREPARED THEREWITH, AND RELATED METHODS

(71) Applicants: DOW SILICONES CORPORATION, Midland, MI (US); DOW GLOBAL TECHNOLOGIES LLC, Midland, MI (US)

(72) Inventors: Richard COOPER, Midland, MI (US); Jodi M. MECCA, Midland, MI (US); Kangsang LEE, Midland, MI (US); Dongchan AHN, Midland, MI (US); Shane MANGOLD, Midland, MI (US); Dan ZHAO, Midland, MI (US); Kyle MCDONALD, Midland, MI (US); Joseph SOOTSMAN, Midland, MI (US)

(21) Appl. No.: 17/793,848

(22) PCT Filed: Jan. 21, 2021
(86) PCT No.: PCT/US2021/014290

§ 371 Date: Jul. 19, 2022

Related U.S. Application Data
(60) Provisional application No. 62/964,455, filed on Jan. 22, 2020.

(51) Int. Cl. C08F 230/08; C09J 143/04; C08K 5/544; C08K 9/02

(52) U.S. Cl. CPC C08F 230/08; C09J 143/04; C08K 5/544; C08K 9/02

(57) ABSTRACT

A curable composition is disclosed. The curable composition comprises (I) an epoxide-functional silicone-acrylate polymer, (II) an aminosiloxane, and (III) a conductive filler. The epoxide-functional silicone-acrylate polymer comprises acrylate-derived monomeric units comprising siloxane moieties, epoxide-functional moieties, and optionally, hydrocarbyl moieties, and the aminosiloxane comprises an average of at least two amine functional groups per molecule. Methods of preparing the curable composition, and a cured product thereof, are also disclosed. A method of forming a composite article comprising a conductive layer with the curable composition is disclosed is also disclosed. The method comprises disposing the curable composition on a substrate, and curing the curable composition to give a conductive layer on the substrate, thereby forming the composite article.

### CROSS REFERENCE TO RELATED APPLICATION

This application claims priority to and all advantages of U.S. Provisional Patent Application No. 62/964,455 filed on 22 Jan. 2020, the content of which is incorporated herein by reference.

### FIELD OF THE INVENTION

The present disclosure generally relates to siloxane-functionalized polymers and, more specifically, to compositions comprising a curable silicone-functionalized acrylate polymer and cured products and composite materials prepared therewith.

### DESCRIPTION OF THE RELATED ART

Silicones are polymeric materials used in numerous commercial applications, primarily due to significant advantages they possess over their carbon-based analogues. More precisely called polymerized siloxanes or polysiloxanes, silicones have an inorganic silicon-oxygen backbone chain ( . . . —Si—O—Si—O—Si—O— . . . ) with organic side groups attached to the silicon atoms. Organic side groups may be used to link two or more of these backbones together. By varying the —Si—O— chain lengths, side groups, and cross-linking, silicones can be synthesized with a wide variety of properties and compositions, with silicone networks varying in consistency from liquid to gel to rubber to hard plastic.

Silicone and siloxane-based materials are known in the art and are utilized in myriad end use applications and environments. The most common silicone materials are based on the linear organopolysiloxane polydimethylsiloxane (PDMS), a silicone oil. Such organopolysiloxanes are utilized in numerous industrial, home care, and personal care formulations. The second largest group of silicone materials is based on silicone resins, which are formed with branched and cage-like oligosiloxanes. Unfortunately, the use of siloxane-based materials in certain applications that may benefit from particular inherent attributes of organopolysiloxanes (e.g. low-loss and stable optical transmission, thermal and oxidative stability, etc.) remains limited due to weak mechanical properties of conventional silicone networks, which may manifest in materials with poor or unsuitable characteristics such as low tensile strength, low tear strength, etc. Moreover, conventional silicone networks and carbon-based polymers are often incompatible and/or possess antagonistic properties with respect to one another.

### BRIEF SUMMARY

A curable composition (the “composition”) is provided. The composition comprises (I) an epoxide-functional silicone-acrylate polymer (the “silicone-acrylate polymer”), (II) an aminosiloxane comprising an average of at least two amine functional groups per molecule, and (III) a conductive filler. The silicone-acrylate polymer has the following general average unit formula (I):

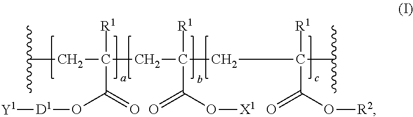

wherein: each Y¹ is an independently selected siloxane moiety; each D¹ is a divalent linking group; each X¹ is an independently selected epoxide-functional moiety; each R¹ is independently selected from H and CH₃; each R² is an independently selected substituted or unsubstituted hydrocarbyl group; subscript a≥1; subscript b≥1; subscript c≥0; and units indicated by subscripts a, b, and c may be in any order in the silicone-acrylate polymer.

Methods of preparing the composition, and a cured product thereof, are also provided. The cured product comprises the reaction product of the silicone-acrylate polymer and the aminosiloxane formed in the presence of the conductive filler.

A method of forming a composite article comprising a conductive layer (the “formation method”), and the composite article formed therewith, are also provided. The formation method comprises disposing the composition on a substrate, and curing the composition to give a conductive layer on the substrate, thereby forming the composite article.

### DETAILED DESCRIPTION OF THE INVENTION

A curable composition (the “composition”) is provided. The curable composition comprises (I) an epoxide-functional silicone-acrylate polymer, (II) an aminosiloxane comprising an average of at least two amine functional groups per molecule, and (III) a conductive filler. Beyond components (I), (II), and (III), which are described in turn below, the composition is not particularly limited. The composition may be free from carrier vehicles, additives, reactants, and/or adjuvants, or, alternatively, may include one or more of such components, as also described below. The composition may be utilized in connection with diverse end-use applications, including in the preparation of functional materials suitable for use in or as composite materials, moldable optics, adhesives, etc.

Component (I) of the composition is an epoxide-functional silicone-acrylate polymer (i.e., the “silicone-acrylate polymer”). The silicone-acrylate polymer (I) generally comprises two or more monomeric units derived from acryloxy-functional monomers, and thus may be characterized, defined, or otherwise referred to as an acrylate or acrylic polymer or copolymer. However, as described below and illustrated by the examples herein, the silicone-acrylate polymer (I) may comprise functionality unrelated to acrylate/acryloxy-functional groups or monomers (e.g. other polymeric moieties, end-capping groups, etc.), but nonetheless may be simply described or referred to as an acrylate polymer, as will be understood by those of skill in the art. The silicone-acrylate polymer (I) is epoxide-functional, i.e., comprises at least one epoxide functional group, as will be understood in view of the description below), and thus may be reacted with compounds comprising epoxide-reactive functional groups such as amines (e.g. in a cross-linking reaction, etc.) and, in particular, with the aminosiloxane (II).

The silicone-acrylate polymer (I) has the following general average unit formula (I):

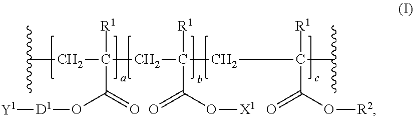

wherein: each Y¹ is an independently selected siloxane moiety; each D¹ is a divalent linking group; each X¹ is an independently selected epoxide-functional moiety; each R¹ is independently selected from H and CH₃; each R² is an independently selected substituted or unsubstituted hydrocarbyl group; subscript a≥1; subscript b≥1; subscript c≥0; and units indicated by subscripts a, b, and c may be in any order in the silicone-acrylate polymer.

With regard to formula (I), as introduce above, Y¹ represents a siloxane moiety. In general, the siloxane moiety Y¹ comprises a siloxane and is otherwise not particularly limited. As understood in the art, siloxanes comprise an inorganic silicon-oxygen-silicon group (i.e., —Si—O—Si—), with organosilicon and/or organic side groups attached to the silicon atoms. As such, siloxanes may be represented by the general formula ([R_{f}SiO_{(4-f)/2}]ₑ)_{g}(R)_{3-g}Si—, where subscript f is independently selected from 1, 2, and 3 in each moiety indicated by subscript e, subscript e is at least 1, subscript g is 1, 2, or 3, and each R is independently selected from hydrocarbyl groups, alkoxy and/or aryloxy groups, and siloxy groups.

Hydrocarbyl groups suitable for R include monovalent hydrocarbon moieties, as well as derivatives and modifications thereof, which may independently be substituted or unsubstituted, linear, branched, cyclic, or combinations thereof, and saturated or unsaturated. With regard to such hydrocarbyl groups, the term “unsubstituted” describes hydrocarbon moieties composed of carbon and hydrogen atoms, i.e., without heteroatom substituents. The term “substituted” describes hydrocarbon moieties where either at least one hydrogen atom is replaced with an atom or group other than hydrogen (e.g. a halogen atom, an alkoxy group, an amine group, etc.) (i.e., as a pendant or terminal substituent), a carbon atom within a chain/backbone of the hydrocarbon is replaced with an atom other than carbon (e.g. a heteroatom, such as oxygen, sulfur, nitrogen, etc.) (i.e., as a part of the chain/backbone), or both. As such, suitable hydrocarbyl groups may comprise, or be, a hydrocarbon moiety having one or more substituents in and/or on (i.e., appended to and/or integral with) a carbon chain/backbone thereof, such that the hydrocarbon moiety may comprise, or be, an ether, an ester, etc. Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof.

Alkoxy and aryloxy groups suitable for R include those having the general formula —ORⁱ, where Rⁱ is one of the hydrocarbyl groups set forth above with respect to R. Examples of alkoxy groups include methoxy, ethoxy, propoxy, butoxy, benzyloxy, and the like, as well as derivatives and modifications thereof. Examples of aryloxy groups include phenoxy, tolyloxy, pentafluorophenoxy, and the like, as well as derivatives and modifications thereof.

Examples of suitable siloxy groups suitable for R include [M], [D], [T], and [Q] units, which, as understood in the art, each represent structural units of individual functionality present in siloxanes, such as organosiloxanes and organopolysiloxanes. More specifically, [M] represents a monofunctional unit of general formula Rⁱⁱ₃SiO_{1/2}; [D] represents a difunctional unit of general formula Rⁱⁱ₂SiO_{2/2}; [T] represents a trifunctional unit of general formula RⁱⁱSiO_{3/2}; and [Q] represents a tetrafunctional unit of general formula SiO_{4/2}, as shown by the general structural moieties below:

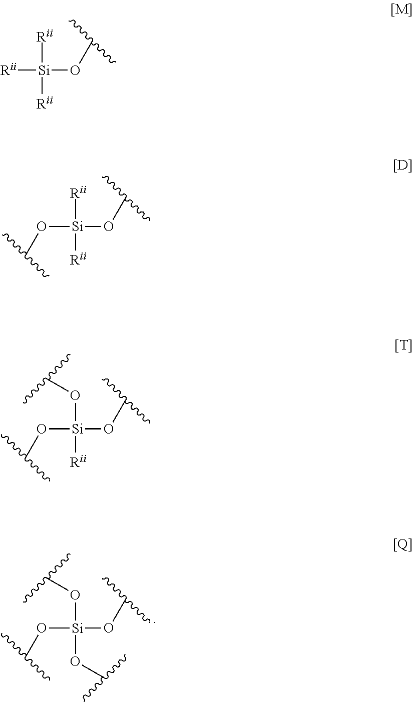

In these general structural moieties, each Rⁱⁱ is independently a monovalent or polyvalent substituent. As understood in the art, specific substituents suitable for each Rⁱⁱ are not limited, and may be monoatomic or polyatomic, organic or inorganic, linear or branched, substituted or unsubstituted, aromatic, aliphatic, saturated or unsaturated, and combinations thereof. Typically, each Rⁱⁱ is independently selected from hydrocarbyl groups, alkoxy and/or aryloxy groups, and siloxy groups. As such, each Rⁱⁱ may independently be a hydrocarbyl group of formula —Rⁱ or an alkoxy or aryloxy group of formula —ORⁱ, where Rⁱ is as defined above (e.g. including any of the hydrocarbyl groups set forth above with respect to R), or a siloxy group represented by any one, or combination, of [M], [D], [T], and/or [Q] units described above.

The siloxane moiety Y¹ may be linear, branched, or combinations thereof, e.g. based on the number and arrangement of [M], [D], [T], and/or [Q] siloxy units present therein. When branched, the siloxane moiety Y¹ may be minimally branched or, alternatively, may be hyperbranched and/or dendritic.

In certain embodiments, the siloxane moiety Y¹ is a branched siloxane moiety having the general formula —Si(R³)₃, wherein at least one R³ is —OSi(R⁵)₃ and each other R³ is independently selected from R⁴ and —OSi(R⁵)₃. In such embodiments, each R⁵ is independently selected from R⁴, —OSi(R⁶)₃, and -[-D²-SiR⁴₂]ₘOSiR⁴₃; where each R⁶ is independently selected from R⁴, —OSi(R⁷)₃, and -[-D²-SiR⁴₂]ₘOSiR⁴₃; where each R⁷ is independently selected from R⁴ and -[-D²-SiR⁴₂]ₘOSiR⁴₃. In each selection, R⁴ is an independently selected substituted or unsubstituted hydrocarbyl group, such as any of those described above with respect to R, D² is a divalent linking group individually selected in each moiety indicated by subscript m, and each subscript m is individually selected such that 0≤m≤100 (i.e., in each selection where applicable).

In such branched siloxane moieties of Y¹, each divalent linking group D² is typically selected from oxygen (i.e., —O—) and divalent hydrocarbon groups. Examples of such hydrocarbon groups include divalent forms of the hydrocarbyl and hydrocarbon groups described above, such as any of those set forth above with respect to R. As such, it will be appreciated that suitable hydrocarbon groups for the divalent linking group D² may be substituted or unsubstituted, and linear, branched, and/or cyclic. Typically, however, when divalent linking group D² is a divalent hydrocarbon group, D² is selected from unsubstituted linear alkylene groups, such as ethylene, propylene, butylene, etc.

In certain embodiments, each divalent linking group D² is oxygen (i.e., —O—), such that each R⁵ is independently selected from R⁴, —OSi(R⁶)₃, and —[OSiR⁴₂]ₘOSiR⁴₃, each R⁶ is independently selected from R⁴, —OSi(R⁷)₃, and —[OSiR⁴₂]ₘOSiR⁴₃, and each R⁷ is independently selected from R⁴ and —[OSiR⁴₂]ₘOSiR⁴₃, where each R⁴ is as defined and described above and each subscript m is as defined above and described below.

As introduced above, each R³ is selected from R⁴ and —OSi(R⁵)₃, with the proviso that at least one R³ is of formula —OSi(R⁵)₃. In certain embodiments, at least two R³ are of formula —OSi(R⁵)₃. In specific embodiments, each R³ is of formula —OSi(R⁵)₃. It will be appreciated that a greater number of R³ being —OSi(R⁵)₃ increases the level of branching in the siloxane moiety Y¹. For example, when each R³ is —OSi(R⁵)₃, the silicon atom to which each R³ is bonded is a [T] siloxy unit. Alternatively, when but two R³ are of formula —OSi(R⁵)₃, the silicon atom to which each R³ is bonded is a [D] siloxy unit. Moreover, when any R³ is of formula —OSi(R⁵)₃, where at least one of those R⁵ is of formula —OSi(R⁶)₃, further siloxane bonds and branching are present in the siloxane moiety Y¹. This is further the case when any R⁶ is of formula —OSi(R⁷)₃. As such, it will be understood by those of skill in the art that each subsequent R⁵⁺ⁿ moiety in the siloxane moiety Y¹ can impart a further generation of branching, depending on the particular selections thereof. For example, at least one R⁵ can be of formula —OSi(R⁶)₃, where at least one of those R⁶ can be of formula —OSi(R⁷)₃. Thus, depending on a selection of each substituent, further branching attributable to [T] and/or [Q] siloxy units may be present in the siloxane moiety Y¹ (i.e., beyond those of other substituents/moieties described above).

Each R⁵ is independently selected from R⁴, —OSi(R⁶)₃, and -[-D²-SiR⁴₂]ₘOSiR⁴₃, where each R⁴, D², and R⁶ is as defined and described above and each subscript m is as defined above and described below. For example, when D² is oxygen (i.e., —O—), R⁵ is selected from R⁴, —OSi(R⁶)₃, and —[OSiR⁴₂]ₘOSiR⁴₃, where 0≤m≤100. Depending on a selection of R⁵ and R⁶, further branching can be present in the siloxane moiety Y¹. For example, when each R⁵ is R⁴, then each —OSi(R⁵)₃ moiety (i.e., each R³ of formula —OSi(R⁵)₃) is a terminal [M] siloxy unit. Said differently, when each R³ is —OSi(R⁵)₃ and each R⁵ is R⁴, then each R³ can be written as —OSiR⁴₃ (i.e., an [M] siloxy unit). In such embodiments, the siloxane moiety Y¹ includes a [T] siloxy unit bonded to group D¹ in formula (I), which [T] siloxy unit is capped by three [M] siloxy units. Moreover, when R⁵ is of formula -[-D²-SiR⁴₂]ₘOSiR⁴₃, and D² is oxygen (i.e., —O—), the siloxane moiety Y¹ includes optional [D] siloxy units (i.e., those siloxy units in each moiety indicated by subscript m) as well as an [M] siloxy unit (i.e., represented by OSiR⁴₃). As such, when each R³ is of formula —OSi(R⁵)₃, R⁵ is of formula -[-D²-SiR⁴₂]ₘOSiR⁴₃, and each D² is oxygen (i.e., —O—), then each R³ includes a [Q] siloxy unit. More specifically, in such embodiments, each R³ is of formula —OSi([OSiR⁴₂]ₘOSiR⁴₃)₃, such that when each subscript m is 0, each R³ is a [Q] siloxy unit endcapped with three [M] siloxy units. Likewise, when subscript m is greater than 0, each R³ includes a linear moiety (i.e., a diorganosiloxane moiety) with a degree of polymerization being attributable to subscript m.

As set forth above, each R⁵ can also be of formula —OSi(R⁶)₃. In embodiments where one or more R⁵ is of formula —OSi(R⁶)₃, further branching can be present in the siloxane moiety Y¹ depending a selection of R⁶. More specifically, each R⁶ is selected from R⁴, —OSi(R⁷)₃, and -[-D²-SiR⁴₂]ₘOSiR⁴₃, where each R⁷ is selected from R⁴ and -[-D²-SiR⁴₂]ₘOSiR⁴₃, and where each subscript m is defined above. For examples, in some embodiments, each D² is oxygen (i.e., —O—), such that each R⁶ is selected from R⁴, —OSi(R⁷)₃, and —[OSiR⁴₂]ₘOSiR⁴₃, where each R⁷ is selected from R⁴ and —[OSiR⁴₂]ₘOSiR⁴₃, and where each subscript m is as defined above and described below.

As introduced above, with respect to the branched siloxane moiety of Y¹, subscript m is from (and including) 0 to 100, alternatively from 0 to 80, alternatively from 0 to 60, alternatively from 0 to 40, alternatively from 0 to 20, alternatively from 0 to 19, alternatively from 0 to 18, alternatively from 0 to 17, alternatively from 0 to 16, alternatively from 0 to 15, alternatively from 0 to 14, alternatively from 0 to 13, alternatively from 0 to 12, alternatively from 0 to 11, alternatively from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively is 0. In certain embodiments, each subscript m is 0, such that the siloxane moiety Y¹ is free from [D] siloxy units.

Importantly, each of R³, R⁴, R⁵, R⁶, and R⁷ are independently selected. As such, the descriptions above relating to each of these substituents is not meant to mean or imply that each substituent is the same. Rather, any description above relating to R⁵, for example, may relate to only one R⁵ or any number of R⁵ in the siloxane moiety Y¹, and so on. In addition, different selections of R³, R⁴, R⁵, R⁶, and R⁷ can result in the same structures. For example, if a particular R³ is —OSi(R⁵)₃, wherein each R⁵ is —OSi(R⁶)₃, where each R⁶ is R⁴, then that particular R³ can be written as —OSi(OSiR⁴₃)₃. Similarly, if a specific R³ is —OSi(R⁵)₃, wherein each R⁵ is -[-D²-SiR⁴₂]ₘOSiR⁴₃, where subscript m is 0, that specific R³ can be written as —OSi(OSiR⁴₃)₃. As shown, these particular selections result in the same final structure for R³, based on different selections for R⁵. To that end, any proviso of limitation on final structure of the siloxane moiety Y¹ is to be considered met by an alternative selection that results in the same structure required in the proviso.

In certain embodiments, each R⁴ is an independently selected alkyl group. In some such embodiments, each R⁴ is an independently selected alkyl group having from 1 to 10, alternatively from 1 to 8, alternatively from 1 to 6, alternatively from 1 to 4, alternatively from 1 to 3, alternatively from 1 to 2 carbon atom(s).

In particular embodiments, each R⁴ is methyl and the siloxane moiety Y¹ has one of the following structures (i)-(iv):

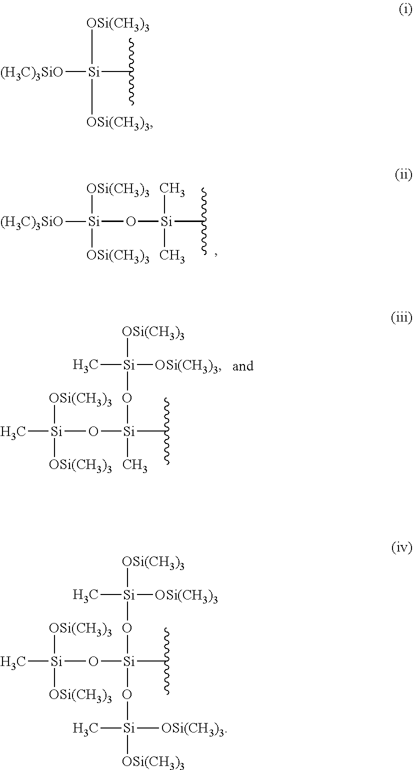

In certain embodiments, the siloxane moiety Y¹ is a linear siloxane moiety having the following general formula:

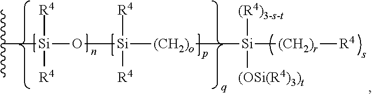

where 0≤n≤100, subscript o is from 2 to 6, subscript p is 0 or 1, subscript q is 0 or 1, subscript r is from 0 to 9, subscript s is 0 or 1, subscript t is 0 or 2, s+t>0, and each R⁴ is an independently selected and as defined above. For example, in some such embodiments, each R⁴ is methyl, such that the siloxane moiety Y¹ is a linear siloxane moiety having the following general formula:

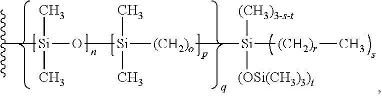

where subscripts n, o, p, q, r, s, and t are as defined above. However, it is to be appreciated that any R⁴ may be selected from other hydrocarbyl groups, such as those described above.

In general, with respect to the linear siloxane moiety of Y¹, subscript n is equivalent to subscript m above, and thus represents a value of from (and including) 0 to 100. Likewise, subscript n may be from 0 to 80, such as from 0 to 60, alternatively from 0 to 40, alternatively from 0 to 20, alternatively from 0 to 19, alternatively from 0 to 18, alternatively from 0 to 17, alternatively from 0 to 16, alternatively from 0 to 15, alternatively from 0 to 14, alternatively from 0 to 13, alternatively from 0 to 12, alternatively from 0 to 11, alternatively from 0 to 10, alternatively from 0 to 9, alternatively from 0 to 8, alternatively from 0 to 7, alternatively from 0 to 6, alternatively from 0 to 5, alternatively from 0 to 4, alternatively from 0 to 3, alternatively from 0 to 2, alternatively from 0 to 1, alternatively is 0. In certain embodiments, subscript n is 0, such that the linear siloxane moiety Y¹ is free from [D] siloxy units in the segment indicated by subscript q (i.e., when q is 1). In other embodiments, however, subscript q is 1 and subscript n is 1, such that the segment of the linear siloxane moiety Y¹ indicated by subscript q comprises at least one [D] siloxy units. For example, in such embodiments, subscript n is from 1 to 100, such as from 5 to 100, alternatively from 5 to 90, alternatively from 5 to 80, alternatively from 5 to 70, alternatively from 7 to 70, such that the segment of the linear siloxane moiety Y¹ indicated by subscript q comprises a number of [D] siloxy units in one of those ranges.

Subscript o is from 2 to 6, such that the segment indicated by subscript o is a C₂-C₆ alkylene group, such as an ethylene, propylene, butylene, pentylene, or hexylene group.

Likewise, subscript r is from 0 to 9, and the segment indicated by subscript r, when r is 1, is a C₁-C₉ alkylene group, such as any of those described above with respect to subscript 0, or a heptylene, octylene, or nonylene group.

Subscripts s and t represent the substitution of the terminal silicon atom of the linear siloxane moiety Y¹. In general, at least one of subscripts s and t is >0 (i.e., s+t>0). For example, in certain embodiments, subscript s is 1 and subscript t is 0. In other embodiments, subscript s is 0 and subscript t is 2. In particular embodiments, the general formula of the linear siloxane moiety Y¹ above is subject to the proviso that subscript t is 0 when subscript s is 1, and subscript t is 2 when subscript s is 0.

In some embodiments, subscript q is 0, and subscript t is 2, such that Y¹ is an MD′M siloxane of general formula:

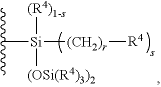

where each R⁴, subscript r, and subscript s, is as defined above. One of skill in the art will recognize that, in such embodiments, different selections within the preceding general formula will achieve the same particular structure of the linear siloxane moiety Y¹. In particular, when subscript r is 0, the linear siloxane moiety Y¹ would be an MD′M siloxane of formula —Si(OSiR⁴₃)₂(R⁴) independent of the selection of subscript s as 0 or 1. For example, in certain embodiments, subscript q is 0, subscript r is 0, subscript t is 2, and each R⁴ is methyl, such that Y¹ is an MD′M siloxane of formula:

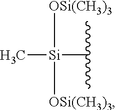

In particular embodiments, subscript p is 0, subscript q is 1, subscript s is 1, subscript t is 0, and each R⁴ is methyl, such that Y¹ has the formula:

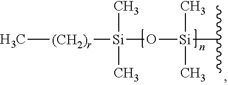

where subscripts n and r are as defined and described above. In some such embodiments, subscript r is 4 or 6. In these or other such embodiments, subscript n is 1, such as from 5 to 70.

In certain embodiments, subscript q is 1, subscript p is 1, and subscript n is 1, such that Y¹ has the formula:

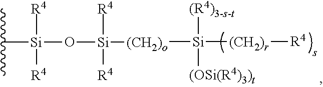

where each R⁴ and subscripts o, r, s, and t are as defined above. For example, in certain such embodiments, subscript o is 2, subscript s is 0, subscript t is 2, and each R⁴ is methyl. In other such embodiments, subscript o is 2, subscript s is 1, subscript r is 0, subscript t is 2, and each R⁴ is methyl. In both of the preceding embodiments, Y¹ has the formula:

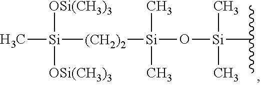

With further regard to formula (I), as introduced above, each D¹ is an independently selected divalent linking group. Divalent linking groups suitable for D¹ are not particularly limited. Typically, the divalent linking group D¹ is selected from divalent hydrocarbon groups. Examples of such hydrocarbon groups include divalent forms of the hydrocarbyl and hydrocarbon groups described above, such as any of those set forth above with respect to R. As such, it will be appreciated that suitable hydrocarbon groups for the divalent linking group D¹ may be substituted or unsubstituted, and linear, branched, and/or cyclic.

In some embodiments, divalent linking group D¹ comprises, alternatively is a linear or branched hydrocarbon moiety, such as a substituted or unsubstituted alkyl group, alkylene group, etc. For example, in certain embodiments, divalent linking group D¹ comprises, alternatively is, a C₁-C₁₈ hydrocarbon moiety, such as a linear hydrocarbon moiety having the formula —(CH₂)_{d}—, where subscript d is from 1 to 18. In some such embodiments, subscript d is from 1 to 16, such as from 1 to 12, alternatively from 1 to 10, alternatively from 1 to 8, alternatively from 1 to 6, alternatively from 2 to 6, alternatively from 2 to 4. In particular embodiments, subscript d is 3, such that divalent linking group D¹ comprises, alternatively is, a propylene (i.e., a chain of 3 carbon atoms). As will be appreciated by those of skill in the art, each unit represented by subscript d is a methylene unit, such that linear hydrocarbon moiety may be defined or otherwise referred to as an alkylene group. It will also be appreciated that each methylene group may independently be unsubstituted and unbranched, or substituted (e.g. with a hydrogen atom replaced with a non-hydrogen atom or group) and/or branched (e.g. with a hydrogen atom replaced with an alkyl group). In certain embodiments, divalent linking group D¹ comprises, alternatively is, an unsubstituted alkylene group.

In some embodiments, divalent linking group D¹ comprises, alternatively is, a substituted hydrocarbon moiety, such as a substituted alkylene group. In such embodiments, divalent linking group D¹ may comprise a carbon backbone having at least 2 carbon atoms and at least one heteroatom (e.g. O, N, S, etc.), such that the backbone comprises an ether moiety, an amine moiety, etc. For example, in particular embodiments, divalent linking group D¹ comprises, alternatively is, an amino substituted hydrocarbon group (i.e., a hydrocarbon comprising a nitrogen-substituted carbon chain/backbone). For example, in some such embodiments, the divalent linking group D¹ is an amino substituted hydrocarbon having formula -D³-N(R⁴)-D³-, where each D³ is an independently selected divalent hydrocarbon group, and R⁴ is as defined above (i.e., a hydrocarbyl group, such as an alkyl group (e.g. methyl, ethyl, etc.). In certain embodiments, R⁴ is methyl in the amino substituted hydrocarbon of the preceding formula. Each D³ typically comprises an independently selected alkylene group, such as any of those described above with respect to divalent linking group D¹. For example, in some embodiments, each D³ is independently selected from alkylene groups having from 1 to 8 carbon atoms, such as from 2 to 8, alternatively from 2 to 6, alternatively from 2 to 4 carbon atoms. In certain embodiments, each D³ is propylene (i.e., —(CH₂)₃—). However, it is to be appreciated that one or both D³ may be, or comprise, another divalent linking group (i.e., aside from the alkylene groups described above). Moreover, each D³ may be substituted or unsubstituted, linear or branched, and various combinations thereof.

With continued regard to formula (I), as introduced above, X¹ represents an epoxide-functional moiety, i.e., a moiety comprising an epoxide group. The epoxide group is not particularly limited, and may be any group comprising an epoxide (e.g. a two carbon three-atom cyclic ether). For example, X¹ may comprise, or be, a cyclic epoxide or a linear epoxide. As understood by those of skill in the art, epoxides (e.g. epoxide groups) are generally described in terms of the carbon skeleton the two epoxide carbons compose (e.g. the epoxyalkane derived from epoxidation of an alkene). For example, linear epoxides generally comprise a linear hydrocarbon comprising two adjacent carbon atoms bonded to the same oxygen atom. Similarly, cyclic epoxides generally comprise cyclic hydrocarbon comprising two adjacent carbon atoms bonded to the same oxygen atom, where at least one, but typically both, adjacent carbon atom is in the ring of the cyclic structure (i.e., is part of both the epoxide ring and the hydrocarbon ring). The epoxide may be a terminal epoxide or an internal epoxide. Specific examples of suitable epoxides for X¹ include epoxyalkyl groups (e.g. epoxyethyl groups, epoxypropyl groups (i.e., oxiranylmethyl groups), oxiranylbutyl groups, epoxyhexyl groups, oxiranyloctyl groups, etc.), epoxycycloalkyl groups (e.g. epoxycyclopentyl groups, epoxycyclohexyl groups, etc.), glycidyloxyalkyl groups (e.g. a 3-glycidyloxypropyl group, a 4-glycidyloxybutyl group, etc.), and the like. One of skill in the art will appreciate that such epoxide groups may be substituted or unsubstituted.

In certain embodiments, X¹ comprises, alternatively is, a hydrocarbyl group substituted with an epoxyethyl group of the formula

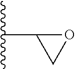 [SMILES: *C1CO1]

or an epoxycyclohexyl group of the formula

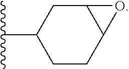 [SMILES: *C1CCC2OC2C1]

In particular embodiments, X¹ is an epoxypropyl group of formula

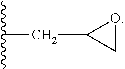 [SMILES: *CC1CO1]

With further regard to formula (I), as introduced above, each R¹ is independently selected from H and CH₃. Said differently, R¹ is independently H or CH₃ in each moiety indicated by subscript a, independently H or CH₃ in each moiety indicated by subscript b, and independently H or CH₃ in each moiety indicated by subscript c. In certain embodiments, R¹ is CH₃ in each moiety indicated by subscript a. In these or other embodiments, R¹ is CH₃ in each moiety indicated by subscript b. In these or other embodiments, R¹ is CH₃ in each moiety indicated by subscript c. In certain embodiments, R¹ is CH₃ in each moiety indicated by subscripts a and b, and R¹ is H in each moiety indicated by subscript c. It will be appreciated, however, that moieties indicated by subscripts a, b, and/or c may comprise a mixture of different R¹ groups. For example, in certain embodiments, R¹ is H in a predominant amount of moieties indicated by subscripts c, R¹ is CH₃ in the remaining moieties indicated by subscripts c.

With further regard to formula (I), as introduced above, R² represents a substituted or unsubstituted hydrocarbyl group. Examples of such hydrocarbyl groups include those described above with respect to R.

In some embodiments, R² is a hydrocarbyl group having from 1 to 20 carbon atoms. In certain such embodiments, R² comprises, alternatively is, an alkyl group. Suitable alkyl groups include saturated alkyl groups, which may be linear, branched, cyclic (e.g. monocyclic or polycyclic), or combinations thereof. Examples of such alkyl groups include those having the general formula CⱼH₂ⱼ₋₂ₖ₊₁, where subscript j is from 1 to 20 (i.e., the number of carbon atoms present in the alkyl group), subscript k is the number of independent rings/cyclic loops, and at least one carbon atom designated by subscript j is bonded to the carboxylic oxygen shown bonded to R² in formula (I) above. Examples of linear and branched isomers of such alkyl groups (i.e., where the alkyl group is free from cyclic groups such that subscript k=0), include those having the general formula CⱼH₂ⱼ₊₁, where subscript j is as defined above and at least one carbon atom designated by subscript j is bonded to the carboxylic oxygen shown bonded to R² in formula (I) above. Examples of monocyclic alkyl groups include those having the general formula CⱼH₂ⱼ₋₁, where subscript j is as defined above and at least one carbon atom designated by subscript j is bonded to the carboxylic oxygen shown bonded to R² in formula (I) above. Specific examples of such alkyl groups include methyl groups, ethyl groups, propyl groups, butyl groups, pentyl groups, hexyl groups, heptyl groups, octyl groups, nonyl groups, decyl groups, undecyl groups, dodecyl groups, tridecyl groups, tetradecyl groups, pentadecyl groups, hexadecyl groups, heptadecyl groups, octadecyl groups, nonadecyl groups, and eicosyl groups, including linear, branched, and/or cyclic isomers thereof. For example, pentyl groups encompass n-pentyl (i.e., a linear isomer) and cyclopentyl (i.e., a cyclic isomer), as well as branched isomers such as isopentyl (i.e., 3-methylbutyl), neopentyl (i.e., 2,2-dimethylpropy), tert-pentyl (i.e., 2-methylbutan-2-yl), sec-pentyl (i.e., pentan-2-yl), sec-isopentyl (i.e., 3-methylbutan-2-yl) etc.), 3-pentyl (i.e., pentan-3-yl), and active pentyl (i.e., 2-methylbutyl).

In certain embodiments, each R² is independently selected from alkyl groups having from 1 to 12 carbon atoms, such as from 1 to 8, alternatively from 2 to 8, alternatively from 2 to 6 carbon atom(s). In such embodiments, each R² is typically selected from methyl groups, ethyl groups, propyl groups (e.g. n-propyl and iso-propyl groups), butyl groups (e.g. n-butyl, sec-butyl, iso-butyl, and tert-butyl groups), pentyl groups (e.g. those described above), hexyl groups, heptyl groups, etc., and the like, as well as derivatives and/or modifications thereof. Examples of derivatives and/or modifications of such alkyl groups include substituted versions thereof. For example, R² may comprise, alternatively may be, a hydroxyl ethyl group, which will be understood to be a derivative and/or a modification of the ethyl groups described above. Likewise, R² may comprise, alternatively may be, an acetoacetoxyethyl group, which will also be understood to be a derivative and/or a modification of the ethyl groups described above (e.g. as an acetoacetoxy-substituted ethyl group), as well as a derivative and/or a modification of other hydrocarbyl groups described above (e.g. a hexyl group substituted with an ester and a ketone, etc.).

In certain embodiments, each R² is independently selected from ethyl, n-butyl, isobutyl, isobornyl, cyclohexyl, neopentyl, 2-ethylhexyl, hydroxyethyl, and acetoacetoxyethyl groups. In particular embodiments, at least one R² is a butyl group (e.g. n-butyl).

Subscripts a, b, and c represent the number of monomeric units shown in formula (I) above, where the silicone-acrylate polymer (I) comprises at least 1 of the moieties indicated by subscript a (i.e., subscript a≥1), at least 1 of the moieties indicated by subscript b (i.e., subscript b≥1), and, optionally, one or more of the moieties indicated by subscript c (i.e., subscript c≥0). Said differently, in general, subscript a is at least 1, alternatively is greater than 1, subscript b is at least 1, alternatively is greater than 1, and subscript c is 0, 1, or greater than 1. In certain embodiments, subscript a is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 25, alternatively from 5 to 25. In these or other embodiments, subscript b is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 20, alternatively from 1 to 10. In certain embodiments, subscript b is a value of from 2 to 30, such as from 2 to 25, alternatively from 2 to 20, alternatively from 2 to 10, alternatively from 2 to 5. In particular embodiments, subscript c is 0. In other embodiments, subscript c≥1. For example, in some such embodiments, subscript c is a value of from 1 to 100, such as from 1 to 80, alternatively from 1 to 70, alternatively from 1 to 60, alternatively from 1 to 50, alternatively from 1 to 40, alternatively from 1 to 30, alternatively from 1 to 20, alternatively from 1 to 15. In some embodiments, the silicone-acrylate polymer (I) has a degree of polymerization (DP) of from 2 to 100, such as from 2 to 50, alternatively from 5 to 50, alternatively from 10 to 50.

In certain embodiments, the moieties indicated by subscript b (i.e., the monomeric units comprising epoxide-functional moieties X¹) compose at least 30 percent of the total number of monomeric units in the silicone-acrylate polymer (I) (i.e., b≥[0.3*(a+b+c)], or at least 30 mol % of the silicone-acrylate polymer (I)). In particular embodiments, silicone-acrylate polymer (I) comprises moieties indicated by subscript b in an amount of at least 35, alternatively at least 40, alternatively from 40 to 60, alternatively from 40 to 50 mol %, based on the total amount of monomeric units a, b, and c. In some embodiments, the silicone-acrylate polymer (I) comprises from 10 to 40 wt. % of the moieties indicated by subscript b, such as from 10 to 30, alternatively from 15 to 30 wt. %, based on the total weight of monomers utilized to prepare the silicone-acrylate polymer (I).

It will be appreciated that the moieties indicated by subscripts a, b, and c are independently selected. As such, for example, when subscript a is at least 2, the silicone-acrylate polymer may comprise more than one moiety indicated by subscript a (i.e., different from one another by different selections of R¹, D¹, and/or Y¹). Likewise, when subscript b is at least 2, the silicone-acrylate polymer may comprise more than one moiety indicated by subscript b (i.e., different from one another by different selections of R¹ and/or X¹). Similarly, when subscript c is at least 2, the silicone-acrylate polymer may comprise more than one moiety indicated by subscript c (i.e., different from one another by different selections of R¹ and/or R²). For example, in certain embodiments, subscript c is 0 and the silicone-acrylate polymer (I) comprises more than one moiety indicated subscript a different from one another by different selections of Y¹, such that formula (I) above can be rewritten into the following general unit formula:

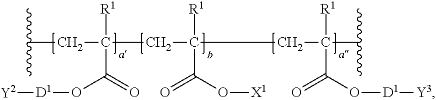

where Y² and Y³ are different selections of the siloxane moiety Y¹ described above, subscript a′ is ≥1, subscript a″ is 1, a′+a″=a (i.e., the sum of subscripts a′ and a″ equal subscript a of formula (I) described above), and each R¹, D¹, X¹, and subscript b is as defined and described above. In some such embodiments, for example, each Y² is independently a branched siloxane moiety having the general formula —Si(R³)₃ and each Y³ is independently a linear siloxane moiety having the following general formula:

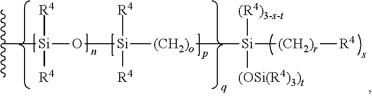

where each variable is as described above with respect to the same particular moieties of the siloxane moiety Y¹. One of skill in the art will appreciate that other combinations and variations within the silicone-acrylate polymer (I), i.e., with respect to the moieties indicated by subscripts a, b, and c, are equally possible within the bounds of the description and examples herein.

In certain embodiments, the silicone-acrylate polymer (I) comprises a weight-average molecular weight (Mw) of at least 500 Da and less than 75000 Da. For example, the silicone-acrylate polymer (I) may comprise a Mw of from 500 to 70000, alternatively from 1000 to 70000, alternatively from 1000 to 60000, alternatively from 1000 to 50000, alternatively from 2000 to 50000, alternatively from 2500 to 50000 Da. In certain embodiments, the silicone-acrylate polymer (I) comprises a number-average molecular weight (Mn) of at least 500 Da and less than 7500 Da. For example, the silicone-acrylate polymer (I) may comprise a Mn of from 500 to 70,000, alternatively from 1000 to 70000, alternatively from 1000 to 60000, alternatively from 1000 to 50000, alternatively from 1000 to 40000, alternatively from 1000 to 35000, alternatively from 2000 to 35000, alternatively from 2500 to 35000 Da. In certain embodiments, the silicone-acrylate polymer comprises a peak molecular weight (Mp) (i.e., an average molecular weight representing the mode of molecular weight distributions) of from 1000 to 50000, alternatively from 2000 to 45000, alternatively from 3000 to 45000 Da. In particular embodiments, the silicone-acrylate polymer comprises a peak molecular weight (Mp) of from 1000 to 20000, such as from 1000 to 15000, alternatively from 1000 to 10000, alternatively from 1000 to 5000 Da. The molecular weight(s) of the silicone-acrylate polymer (I) may be readily determined by techniques known in the art, such as via gel permeation chromatography (GPC) against polystyrene standards (e.g. using size exclusion chromatography (GPC/SEC)).

In general, the composition comprises the silicone-acrylate polymer (I) in an amount of from 5 to 25 wt. %, based on the total weight of the composition. In certain embodiments, the composition comprises the silicone-acrylate polymer (I) in an amount of from 5 to 20 wt. %, such as from 5 to 19, alternatively from 5 to 18, alternatively from 6 to 18, wt. %, based on the total weight of components (I), (II), and (III) in the composition. In some embodiments, the composition comprises the silicone-acrylate polymer (I) in an amount of from 5 to 20 wt. %, such as from 5 to 19, alternatively from 5 to 18, alternatively from 6 to 18, wt. %, based on the total weight of the composition.

As introduced above, component (II) of the composition is an aminosiloxane. In general, the aminosiloxane (II) comprises, alternatively is, an amine-functional polysiloxane having a silicone backbone and an average of at least two amine functional groups per molecule. The amine functional groups may be located anywhere along the silicone backbone, such as in terminal positions, pendant positions, or both. The amine functional groups are configured to be reactive with the epoxide groups of the silicone-acrylate polymer (I) (i.e., those present in the epoxide-functional moieties X¹ described above), such that the silicone-acrylate polymer (I) and the aminosiloxane (II) may be reacted together (e.g. in a cross-linking reaction) to prepare a cured/networked product therefrom. Aside from the amine functional groups, the aminosiloxane (II) is not particularly limited, and may comprise any combination of [M], [D], [T] and/or [Q] siloxy units, as such units are described above, so long as the aminosiloxane (II) includes an average of at least two amine functional groups per molecule. The siloxy units of the aminosiloxane (II) can be combined in various manners to form cyclic, linear, branched and/or resinous (e.g. three-dimensional networked) structures, i.e., in the silicone backbone. As such, the silicone backbone of the aminosiloxane (II) may be monomeric, polymeric, oligomeric, linear, branched, cyclic, and/or resinous depending on the selection of [M], [D], [T] and/or [Q] units therein. Likewise, the aminosiloxane (II) itself may be generally linear, branched, partly branched, cyclic, resinous (i.e., have a three-dimensional network), or may comprise a combination of different structures.

In general, the aminosiloxane (II) may have the fully condensed formula: R⁸ᵢSiO_{(4-i)/2}, where each R⁸ is independently selected from hydrocarbyl groups, alkoxy and/or aryloxy groups, and amine groups, with the proviso that in each molecule, an average of at least two of R⁸ each include an amine group, and where subscript i is selected such that 0<i≤3.5. In certain embodiments, the aminosiloxane (II) may have the general average unit formula [R⁸ᵢSiO_{(4-i)/2}]ₕ, where: subscript h≥1; subscript i is independently selected from 1, 2, and 3 in each moiety indicated by subscript h, with the proviso that h+i>2; and each R⁸ is independently selected from hydrocarbyl groups, alkoxy and/or aryloxy groups, siloxy groups, and amine groups (i.e., such as any of those described above), with the proviso that an average of at least two R⁸ are amine groups per molecule of the aminosiloxane (II).

Suitable hydrocarbyl groups, alkoxy groups, and aryloxy groups for R⁸ are as described above with respect to R, and suitable amine groups for R⁸ include any of the hydrocarbyl or alkoxy groups described above substituted with a primary or secondary amine group (i.e., an epoxide-reactive amine group). In certain embodiments, each R⁸ is independently selected from hydrocarbyl groups, alkoxyaryloxy groups, and amine groups. In certain embodiments, each R⁸ is independently selected from alkyl groups having from 1 to 20 carbon atoms (e.g. methyl, ethyl, and propyl groups (i.e., n-propyl and isopropyl groups), etc.), aryl groups having from 6 to 20 carbon atoms (e.g. phenyl groups, etc.), and halogenated alkyl groups having from 1 to 20 carbon atoms (e.g. chloromethyl, chloropropyl, and trifluoropropyl groups, etc.), and amine groups. In specific embodiments, each R⁸ that is not an amine group is a methyl group.

The average unit formula above for the aminosiloxane (II) may be alternatively written as [R⁸₃SiO_{1/2}]ₓ[R⁸₂SiO_{2/2}]_{y}[⁸SiO_{3/2}]_{z}[SiO_{4/2}]_{w}, where R⁸ is as defined above, and subscripts x, y, z, and w are each mole fractions representing [M], [D], [T] and [Q] units, respectively, such that x+y+z+w=1, with the proviso that x+y+z>0. One of skill in the art understands how such [M], [D], [T] and [Q] units and their molar fractions influence subscripts x, y, z, and w in the average unit formula above. For example, [T] units (e.g. indicated by subscript z) and/or [Q] units (e.g. indicated by subscript w) are typically present in aminosiloxane resins, whereas aminosiloxane polymers (e.g. aminosilicones) are typically free from such [T] units and/or [Q] units. [D] units indicated by subscript x are typically present in both aminosiloxane resins polymers. However, such [D] units may also be present in aminosiloxane resins and branched aminosiloxanes. In certain embodiments, the aminosiloxane (II) is substantially free from, alternatively is free from, [Q] units (e.g. where subscript w is 0), such that the aminosiloxane (II) has the following general formula:

[R⁸₃SiO_{1/2}]ₓ[R⁸₂SiO_{2/2}]_{y}[⁸SiO_{3/2}]_{z},

where R⁸ and subscripts x, y, and z are as defined above.

In certain embodiments, the aminosiloxane (II) may be substantially linear, alternatively is linear. In such embodiments, the aminosiloxane (II) may have the condensed formula: R⁸ᵢSiO_{(4-i)/2}, where each R⁸ is independently selected and as defined above, and where subscript i is selected such that 1.9≤i≤2.2. Such linear examples of the aminosiloxane (II) may present as a flowable liquid under ambient conditions (e.g. at 25° C.), e.g. such as when the aminosiloxane (II) comprises a viscosity of from 10 to 30,000,000 mPa·s, such as from 10 to 10,000,000 alternatively from 100 to 1,000,000, alternatively from 100 to 100,000 mPa·s at 25° C. (e.g. as determined via viscometer, such as a Brookfield LV DV-E viscometer equipped with an appropriate spindle). In certain embodiments, the aminosiloxane (II) exhibits a dynamic viscosity of less than 300, alternatively less than 200, alternatively of from 10 to 200 centipoise (cP) at 25° C.

When substantially linear or linear, the aminosiloxane (II) is substantially free from, alternatively is free from, both [T] and [Q] units (e.g. where z=0 and w=0 in the formulae above), such that the aminosiloxane (II) is an MDM-type polysiloxane having the following general formula:

[R⁸₃SiO_{1/2}]ₓ[R⁸₂SiO_{2/2}]_{y},

where R⁸ and subscripts x and y are as defined above. As each of the units represented by subscripts x and y are independently selected, and at least two R⁸ are amine groups per molecule of the aminosiloxane (II), the preceding formula may be rewritten as:

[R¹⁰R⁹₂SiO_{1/2}]_{x′}[R¹⁰R⁹SiO_{2/2}]_{y′}[R⁹₂SiO_{3/2}]_{y″}[R⁹₃SiO_{1/2}]_{x″},

where each R⁹ is an independently selected monovalent hydrocarbon group; each R¹⁰ is an amino-functional group; subscripts x′ and x″ are each independently 0, 1, or 2; subscript y′ is ≥0; and subscript y″ is ≥0, with the provisos that x′+x″≥2, x′+y′≥2, and y′+y″≥1. In such embodiments, x′+x″+y′+y″ is generally from 3 to 2,000. For example, in some embodiments, subscript y″ may be from 0 to 1000, alternatively from 1 to 500, alternatively from 1 to 200. In these or other embodiments, subscript y′ is from 2 to 500, alternatively from 2 to 200, alternatively from 2 to 100. In such embodiments, x′ and x″ are each typically from 0 to 10, such as from 2 to 6.

Monovalent hydrocarbon groups suitable for R⁹ are exemplified by alkyl groups having from 1 to 6 carbon atoms, aryl groups having from 6 to 10 carbon atoms, halogenated alkyl groups having from 1 to 6 carbon atoms, halogenated aryl groups having from 6 to 10 carbon atoms, aralkyl groups having from 7 to 12 carbon atoms, and halogenated aralkyl groups having from 7 to 12 carbon atoms, where alkyl, aryl, and halogenated alkyl, aralkyl, etc., are described and exemplified above. In some embodiments, each R⁹ is an alkyl group. For example, in certain embodiments, each R⁹ is independently methyl, ethyl or propyl. It will be appreciated, however, that each R⁹ may be selected to be the same as or different from any other R⁹, e.g. in terms of which group the particular R⁹ represents. In some embodiments, however, each R⁹ is a methyl group.

When the aminosiloxane (II) is substantially linear, alternatively is linear, the at least two amine functional groups may be bonded to silicon atoms in pendent positions, terminal positions, or in both pendent and terminal locations. As a specific example, where each R⁹ is methyl, the aminosiloxane (II) may have but only pendant amine functional groups and thus comprise the average unit formula [(CH₃)₃SiO_{1/2}]₂[(CH₃)R¹⁰SiO_{2/2}]_{y′}[(CH₃)₂SiO_{2/2}]_{y″}, where subscripts y′ and y″ are defined above, with the proviso that y′ is ≥2, and each R¹⁰ is an independently selected amine functional group as defined and described above. With regard to this average unit formula, any methyl group may be replaced with a different monovalent hydrocarbon group (such as alkyl or aryl). Alternatively, the aminosiloxane (II) may have but only terminal amine functional groups, and thus comprise the average formula: R¹⁰(CH₃)₂SiO[(CH₃)₂SiO]_{y″}Si(CH₃)₂R¹⁰, where subscript y″ and R¹⁰ are as defined above. With regard to this average formula, where the aminosiloxane (II) may be defined or otherwise described as a dimethyl polysiloxane terminated with amine functional groups, it is to be appreciated that any methyl group may be replaced with a different monovalent hydrocarbon group, and each R¹⁰ may be any of the amine functional groups described herein. Alternatively, the aminosiloxane (II) may have both terminal and pendant amine functional groups, and thus comprise the average unit formula: [R¹⁰(CH₃)₂SiO_{1/2}]_{x′}[R¹⁰(CH₃)SiO_{2/2}]_{y′}[(CH₃)₂SiO_{2/2}]_{y″}, where each of subscripts x′, y′, y″, and R¹⁰ are as defined above.

The amine functional groups of the aminosiloxane (II), e.g. represented by R¹⁰ in the preceding average unit formulae are capable of forming a N—C bond with an oxyranyl carbon atom of the silicone-acrylate polymer (I) (i.e., those present in the epoxide-functional moieties X¹ described above), and are otherwise not particularly limited. Suitable amine functional groups for R¹⁰ are exemplified by aminoalkyl, aminoaryl, aminoalkaryl, and aminoaralkyl groups bonded directly to a silicon atom of the siloxane backbone of the aminosiloxane (II), or to an oxygen bonded to such a silicon atom (e.g. as an aminoalkoxy group, an aminoaryloxy group, etc.).

In particular embodiments, the aminosiloxane (II) has the following general formula:

[R⁹₃SiO_{1/2}]ₓ[(H₂N-D³-)(R⁹)₂SiO_{1/2}]_{x′}[R⁹₂SiO_{2/2}]_{y}[(H₂N-D³-)(R⁹)SiO_{2/2}]_{y′},

each D³ is an independently selected divalent linking group, and R⁹ and subscripts x, x′, y, and y′ are as defined above. with the provisos that 0≤x+x′<1, 0<y+y′<1, and x′+y′>0.

Divalent linking groups suitable for D³ are not particularly limited. Typically, each divalent linking group D³ is selected from a divalent hydrocarbon group, such as any of those described above with respect to D¹. As such, it will be appreciated that suitable hydrocarbon groups for the divalent linking group D³ may be substituted or unsubstituted, and linear, branched, and/or cyclic. Typically, each, divalent linking group D³ comprises, alternatively is a substituted or unsubstituted linear or branched alkyl group. In certain embodiments, each divalent linking group D³ comprises, alternatively is, an unsubstituted alkylene group. Examples of such alkylene groups include any of those described herein, such as a linear alkylene group having from 1 to 12 carbon atoms, optionally substituted with an oxygen atom in the chain. For example, in certain embodiments, D³ comprises an oxygen atom bonded to a silicon atom of the silicone backbone of the aminosiloxane (II) (e.g. one of the silicon atoms of the units indicated by subscripts x′ and/or y′ above).

With regard to the silicon-bonded substituents represented in the various formulae above, e.g. by each R⁸ that is not an amine group, each R⁹, etc., the aminosiloxane (II) may be characterized in terms of content of any particular substituent. For example, as will be understood by those of skill in the art, the aminosiloxane (II) may be characterized in terms of methyl content (i.e., the number or proportion of each R⁸, R⁹, etc. that is a methyl group), phenyl content (i.e., the number or proportion of each R⁸, R⁹, etc. that is a phenyl group), etc. In certain embodiments, for example, the aminosiloxane (II) has a high methyl content, such as a methyl content of at least 90, alternatively at least 95, alternatively at least 98, alternatively at least 99, alternatively at least 99.5, alternatively at least 99.9, alternatively at least 99.99%, based on the total number of silicon-bonded substituents that are not the amine groups. In particular embodiments, the aminosiloxane (II) has a low phenyl content, such as a phenyl content of less than 10, alternatively less than 5, alternatively less than 2, alternatively less than 1, alternatively less than 0.5, alternatively less than 0.1, alternatively less than 0.01%, based on the total number of silicon-bonded substituents that are not the amine groups.

When the aminosiloxane (II) is the substantially linear polyorganosiloxane, the aminosiloxane (II) can be exemplified by a dimethylpolysiloxane capped at both molecular terminals with amino-functional dimethylsiloxy groups, a methylphenylpolysiloxane capped at both molecular terminals with amino-functional dimethylsiloxy groups, a copolymer of a methylphenylsiloxane and dimethylsiloxane capped at both molecular terminals with amino-functional dimethylsiloxy groups, a copolymer of a dimethylsiloxane and diphenylsiloxane capped at both molecular terminals with amino-functional dimethylsiloxy groups, a copolymer of a dimethylsiloxane, methylphenylsiloxane, and diphenylsiloxane capped at both molecular terminals with amino-functional dimethylsiloxy groups, a copolymer of an amino-functional methylsiloxane and a methylphenylsiloxane capped at both molecular terminals with trimethylsiloxy groups, a copolymer of an amino-functional methylsiloxane and a diphenylsiloxane capped at both molecular terminals with trimethylsiloxy groups, and a copolymer of an amino-functional methylsiloxane, methylphenylsiloxane, and a dimethylsiloxane capped at both molecular terminals with trimethylsiloxy groups.

In certain embodiments, the aminosiloxane (II) comprises a weight-average molecular weight (Mw) of at least 500 Da and less than 5000 Da. For example, the aminosiloxane (II) may comprise a Mw of from 500 to 4000, alternatively from 500 to 3500, alternatively from 500 to 3000, alternatively from 500 to 2500, alternatively from 500 to 2000, alternatively from 750 to 2000, alternatively from 750 to 1500, alternatively from 750 to 1250 Da. In certain embodiments, the aminosiloxane (II) comprises a number-average molecular weight (Mn) of at least 500 Da and less than 5000 Da. For example, the aminosiloxane (II) may comprise a Mn of from 500 to 4000, alternatively from 500 to 3500, alternatively from 500 to 3000, alternatively from 500 to 2500, alternatively from 500 to 2000, alternatively from 750 to 2000, alternatively from 750 to 1500, alternatively from 750 to 1250 Da. In some embodiments, the aminosiloxane (II) has a degree of polymerization (DP) of from 2 to 100, such as from 2 to 75, alternatively from 2 to 50, alternatively from 5 to 50, alternatively from 5 to 25. In the above embodiments, the relatively-low molecular weight ranges set forth for the aminosiloxane (II) provide the composition with suitable fluidity without need for any carrier vehicle/solvent, as described in further detail below. However, one of skill in the art will appreciate that such carrier vehicle/solvent may be utilized, even with such relatively-low molecular weight aminosiloxanes, without departing from the scope of this disclosure. For example, in certain embodiments, the composition comprises a carrier vehicle, which may be removed after curing the composition, e.g. to shrink the volume of a cured product to alter (e.g. increase) the conductivity thereof. Likewise, such carrier vehicle/solvent may be utilized in combination with aminosiloxanes having molecular weights outside (e.g. above) the ranges set forth above, which may also be suitable for use as the aminosiloxane (II).

In general, the composition comprises the aminosiloxane (II) in an amount of from 1 to 20 wt. %, based on the total weight of the composition. In certain embodiments, the composition comprises the aminosiloxane (II) in an amount of from 1 to 15 wt. %, such as from 1 to 14, alternatively from 2 to 14 wt. %, based on the total weight of components (I), (II), and (III) in the composition. In some embodiments, the composition comprises the aminosiloxane (II) in an amount of from 1 to 15 wt. %, such as from 1 to 14, alternatively from 2 to 14 wt. %, based on the total weight of the composition.

As introduced above, the amine functional groups of the aminosiloxane (II) are configured to be reactive with the epoxide groups of the silicone-acrylate polymer (I) to prepare a cured/networked product therefrom. More specifically, the silicone-acrylate polymer (I) and the aminosiloxane (II) are reactive with each other via a cross-linking reaction based on ring-opening amine-epoxide reactions between the amine functional groups of component (II) and the epoxide groups in X¹ of component (I). As will be appreciated by those of skill in the art, the cross-linking reaction prepares an aminosiloxane-silicone-acrylate copolymer (the “copolymer”), which may generally be described or otherwise denoted as an aminosiloxane cross-linked silicone-acrylate copolymer.

The relative amounts of the components (I) and (II) utilized in the composition may vary, e.g. based upon the silicone-acrylate polymer (I) and/or aminosiloxane (II) selected, the type of conductive filler (III) utilized, etc. In certain embodiments, an excess (e.g. molar and/or stoichiometric) of one of components (I) and (II) is utilized to maximize the cross-linking of the silicone-acrylate polymer (I) and/or to fully consume the aminosiloxane (II). In general, the silicone-acrylate polymer (I) and the aminosiloxane (II) are utilized in the composition in a molar ratio of from 10:1 to 1:10, alternatively from 8:1 to 1:8, alternatively from 6:1 to 1:6, alternatively from 4:1 to 1:4, alternatively from 2:1 to 1:2, alternatively 1:1, (I):(II). It will be appreciated, however, that ratios outside of the specific ranges above may also be utilized. For example, in certain embodiments, the aminosiloxane (II) is utilized in a gross excess (e.g. in an amount of ≥5, alternatively ≥10, alternatively ≥15, alternatively ≥20, times the stoichiometric amount of cross-linkable groups of the silicone-acrylate polymer (I)), such as when the aminosiloxane (II) is utilized as a carrier (i.e., a solvent, diluent, etc.), e.g. for subsequent removal. Regardless, one of skill in the art will readily select the particular amounts and ratios of the various components to prepare the copolymer according to the embodiments described herein, including the theoretical maximum reactivity ratios described above, the presence or exclusion of any carrier vehicle(s), the particular components utilized, etc.

In certain embodiments, the silicone-acrylate polymer (I) and the aminosiloxane (II) are utilized in a stoichiometric ratio of from 10:1 to 1:10, alternatively from 8:1 to 1:8, alternatively from 6:1 to 1:6, alternatively from 4:1 to 1:4, alternatively from 2:1 to 1:2, alternatively of 1:1, alternatively of 1:0.8, [X¹]:[NH], where [X¹] represents the number of epoxide moieties X¹ of the silicone-acrylate polymer (I) and [NH] represents the number of amine functional groups of the aminosiloxane (II), (i.e., the number of amine-functional R⁸, R¹⁰, etc. in myriad embodiments described above), which is generally at least 2. More specifically, as understood by those of skill in the art, the cross-linking of the silicone-acrylate polymer (I) with the aminosiloxane (II) occurs at a theoretical maximum based on the number of cross-linkable groups X¹ present within the silicone-acrylate polymer (I). In particular, with reference to general formula (I) of the silicone-acrylate polymer (I) above, each epoxide-functional moiety designated by X¹ can be reacted with one of the amine functional groups of the aminosiloxane (II), of which there is an average, per molecule, of at least two, such that one molar equivalent of the aminosiloxane (II) is needed for every two epoxide-functional moieties designated by X¹ of the silicone-acrylate polymer (I) to achieve a theoretically complete (i.e., maximum) cross-linking reaction. Likewise, the theoretical maximum stoichiometric ratio of the reaction of the silicone-acrylate polymer (I) with the aminosiloxane (II) is 1:1 [X¹]:[NH], i.e., where a molecule of the aminosiloxane requires two amine groups to cross-link two molecules of the epoxide-functional moiety, which each require one epoxide group to participate in the reaction.

In particular embodiments, the silicone-acrylate polymer (I) and the aminosiloxane (II) are utilized in a stoichiometric ratio of from 0.75:1 to 2.5:1 [NH]:[X¹], such as from 0.75:1 to 2.25:1, alternatively from 0.75:1 to 2:1, alternatively from 0.75:1 to 1.75:1, alternatively from 0.75:1 to 1.5:1. [NH]:[X¹]. As will be understood in the art, the ratio [NH]:[X¹] may be referred to as the cure stoichiometry of the curable composition, may be defined as the molar ratio of active amine hydrogens to epoxy groups attributable to the aminosiloxane (II) and silicone-acrylate polymer (I), respectively.

In general, the particular silicone-acrylate polymer (I) and aminosiloxane (II) utilized in the composition are not limited aside from the parameters and characteristics described herein. In certain embodiments, however, the silicone-acrylate polymer (I) and aminosiloxane (II) are selected in view of each other, e.g. based on the compatibility of the components with each other. For example, in some embodiments, the silicone-acrylate polymer (I) and aminosiloxane (II) are selected to give a transparent liquid when combined. More particularly, in such embodiments, the aminosiloxane (II) is compatible, alternatively is miscible with the silicone-acrylate polymer (I). In particular examples of these embodiments, the aminosiloxane (II) is compatible, alternatively is miscible with the silicone-acrylate polymer (I) at room temperature. In other such embodiments, the transparent liquid form may be achieved by combining together components (I) and (II) and subsequently heating the combination (e.g. at a mildly elevated temperature, such as from greater than room temperature to less than 150, alternatively less than 125, alternatively less than 100, ° C.) to compatibilize components (I) and (II), and then cooling or otherwise allowing the composition to cool to room temperature to give the transparent liquid.

Component (III) of the composition is a conductive filler. The conductive filler (III) may be electrically conductive, thermally conductive, or both thermally and electrically conductive, and is otherwise not particularly limited. General examples of conductive fillers include various inorganic fillers, organic fillers, and combinations thereof, including treated fillers and materials otherwise comprising a filler, which exhibit electrical and/or thermal conductivity (K) under the conditions described herein (e.g. an electrical conductivity (K) of greater than 1×10⁶ S/m and/or a volume resistivity (p) less than 0.001 Ohm-cm at 20° C.). As used herein, volume resistivity (p) and electrical conductivity (K) refer to bulk volume resistivity and bulk electrical conductivity. If a volume resistivity value and electrical conductivity value inadvertently conflict, the volume resistivity value controls.

Some examples of suitable conductive fillers include those comprising one or more components selected from pure metals (e.g. bismuth, lead, tin, antimony, indium, cadmium, zinc, silver, copper, nickel, aluminum, iron, metallic silicon, etc.), alloys (e.g. comprising at least two metals, such as bismuth, lead, tin, antimony, indium, cadmium, zinc, silver, copper, nickel, aluminum, iron, metallic silicon, etc.), metal oxides (e.g. alumina, zinc oxide, silicon oxide, magnesium oxide, beryllium oxide, chromium oxide, titanium oxide, barium titanate, zirconium oxide, strontium titanate, cerium oxide, cobalt oxide, indium tin oxide, hafnium oxide, yttrium oxide, tin oxide, niobium oxide, iron oxide, etc.), metal hydroxides, metal nitrides (e.g. boron nitride, aluminum nitride, silicon nitride, etc.), metal carbides (e.g. silicon carbide, boron carbide, titanium carbide, etc.), metal silicides (e.g. magnesium silicide, titanium silicide, zirconium silicide, tantalum silicide, niobium silicide, chromium silicide, tungsten silicide, molybdenum silicide, etc.), carbon (e.g. include diamond, graphite, a fullerene, carbon nanotubes, graphene, activated carbon and monolithic carbon black), soft magnetic alloys (e.g. Fe—Si alloys, Fe—Al alloys, Fe—Si—Al alloys, Fe—Si—Cr alloys, Fe—Ni alloys, Fe—Ni—Co alloys, Fe—Ni—Mo alloys, Fe—Co alloys, Fe—Si—Al—Cr alloys, Fe—Si—B alloys, Fe—Si—Co—B alloys, etc.), ferrites (e.g. Mn—Zn ferrites, Mn—Mg—Zn ferrites, Mg—Cu—Zn ferrites, Ni—Zn ferrites, Ni—Cu—Zn ferrites, Cu—Zn ferrites, etc.), and the like, as well as combinations thereof.

Examples of electrically conductive fillers in particular generally include those comprising a metal or a conductive non-metal, as well as particulate fillers having a core of particles (e.g. including copper, solid glass, hollow glass, mica, nickel, ceramic fiber, polymerics such as polystyrene, polymethylmethacrylate, etc.) and an outer surface comprising a metal (e.g. a noble metal such as silver, gold, platinum, palladium, and alloys thereof, or a base metal such as nickel, aluminum, copper, or steel) or other electrically conductive material (e.g. graphene). Examples of thermally conductive fillers in particular generally include those comprising aluminum, copper, gold, nickel, silver, alumina, magnesium oxide, beryllium oxide, chromium oxide, titanium oxide, zinc oxide, barium titanate, diamond, graphite, carbon or silicon nano-sized particles, boron nitride, aluminum nitride, boron carbide, titanium carbide, silicon carbide, and tungsten carbide.

The conductive filler (III) may comprise, alternatively may be, a mineral filler. Examples of mineral fillers include titanium dioxide, aluminum trihydroxide (“ATH”), magnesium dihydroxide, mica, kaolin, calcium carbonate, non-hydrated, partially hydrated, or hydrated fluorides, chlorides, bromides, iodides, chromates, carbonates, hydroxides, phosphates, hydrogen phosphates, nitrates, oxides, and sulphates of sodium, potassium, magnesium, calcium, and barium; zinc oxide, aluminum oxide, antimony pentoxide, antimony trioxide, beryllium oxide, chromium oxide, iron oxide, lithopone, boric acid or a borate salt such as zinc borate, barium metaborate or aluminum borate, mixed metal oxides such as aluminosilicate, vermiculite, silica including fumed silica, fused silica, precipitated silica, quartz, sand, and silica gel; rice hull ash, ceramic and glass beads, zeolites, metals such as aluminum flakes or powder, bronze powder, copper, gold, molybdenum, nickel, silver powder or flakes, stainless steel powder, tungsten, hydrous calcium silicate, barium titanate, silica-carbon black composite, functionalized carbon nanotubes, cement, fly ash, slate flour, ceramic or glass beads, bentonite, clay, talc, anthracite, apatite, attapulgite, boron nitride, cristobalite, diatomaceous earth, dolomite, ferrite, feldspar, graphite, calcined kaolin, molybdenum disulfide, perlite, pumice, pyrophyllite, sepiolite, zinc stannate, zinc sulphide, wollastonite, and the like, as well as derivatives, modifications, and combinations thereof. The conductive filler (III) may comprise, alternatively may be, a dielectric filler. Examples of dielectric fillers include ferroelectric fillers, paraelectric fillers and combinations thereof, and can impart a relatively high dielectric constant so as to enable a composition to store an electric charge. Examples of these dielectric fillers include lead titanate zirconate, barium titanate, calcium metaniobate, bismuth metaniobate, iron metaniobate, lanthanum metaniobate, strontium metaniobate, lead metaniobate, lead metatantalate, strontium barium titanate, sodium barium niobate, potassium barium niobate, rubidium barium niobate, titanium oxide, tantalum oxide, hafnium oxide, niobium oxide, aluminum oxide, and steatite.

The conductive filler (III) may comprise one or more of the fillers described above in any form, such as in particulate form. Such particles are not generally limited, and may independently be in the shape of cuboidals, flakes, granules, irregulars, rods, needles, powders, spheres, or combinations thereof. In certain embodiments, the conductive filler (III) comprises particles having a maximum particle size of 500 μm, alternatively 200 μm, alternatively 100 μm, alternatively 50 μm, alternatively 30 μm. In these or other embodiments, the conductive filler (III) comprises particles having a minimum particle size of 0.0001 μm, alternatively 0.0005 μm, alternatively 0.001 μm. In certain embodiments, the conductive filler (III) comprises particles having a median particle size of from 0.005 to 20 μm. In some embodiments, the conductive filler (III) comprises particles having a median particle size of from 0.005 to 100 μm, such as from 0.005 to 50, alternatively from 0.01 to 50 μm. Particle sizes may be determined by particle size distribution analysis and reported as a median particle size in μm (D<50), alternatively as the diameter in μm below which 10% (D¹⁰), 50% (D⁵⁰) and 90% (D⁹⁰) of the cumulative particle size distribution is found. The particles may have an aspect ratio ranging from 1:1 (approximately spherical) to 3,000:1.

The particles may be surface treated, e.g. to improve (i.e., increase) wettability (e.g. by the other components of the composition) and/or dispersability (e.g. in the composition).

Examples of surface treatments generally include contacting the particles with a chemical substance such as an acid, base, compatibilizer, lubricant, processing aid, etc., which may collectively be referred to as “treating agents”. Examples of such treating agents are not limited, and are exemplified by aqueous sodium hydroxide, carboxylic acids and esters (e.g. fatty acids, fatty esters, etc.), hydrocarbon vehicles, silicon-containing compounds (e.g. organochlorosilanes, organosiloxanes, organodisilazanes, organoalkoxysilanes, etc.), sulfuric acid, etc. Examples of silicon-containing compound treating agents include, and the like, as well as combinations thereof.

In certain embodiments, the conductive filler (III) comprises silver particles, such as silver flakes, silver coated core particles, or any other finely divided solid form of the silver. In some such embodiments, the silver particles comprise at least 90 atomic percent (at. %) Ag, such as >95 at. % Ag, alternatively >98 at. %, alternatively >99.99 at. % Ag. However, the silver particles may comprise much lower amounts of silver, such as when silver-coated core particles are utilized. Such silver-coated core particles, as well as the other coated core particles introduced above, may comprise a core that is a solid or liquid form of an inner support material. The inner support material may be a solid or, alternatively, a liquid, such as a liquid having a boiling point >300° C. (e.g. mercury). In each coated core particle, the inner support material may be a single particle, alternatively a cluster or agglomerate of multiple particles. In general, the inner support material may comprise, alternatively may be, aluminum; silica glass; carbon; a ceramic; copper; iron; lithium; molybdenum; nickel; organic polymer; palladium; platinum; silica; tin; tungsten; zinc; or a metal alloy of any two or more of aluminum, copper, iron, lithium, molybdenum, nickel, palladium, platinum, tin, tungsten, and zinc; or a physical blend of any two or more of aluminum; silica glass; carbon; a ceramic; copper; iron; lithium; molybdenum; nickel; organic polymer; palladium; platinum; silica; tin; tungsten; zinc; or a metal alloy, such as any of those described herein. The inner support material may be electrically conductive or electrically non-conductive (insulating). Electrically non-conductive inner support materials may comprise a silica glass (e.g. soda-lime-silica glass or borosilicate glass), a diamond polymorph of carbon, a silica, an organic polymer, an organosiloxane polymer, or a ceramic.

Typically, the conductive filler (III) comprises particles exhibiting a volume resistivity (p) less than 0.01 Ohm-cm. In certain embodiments, the conductive filler (III) comprises particles exhibiting a volume resistivity (p) of from less than 0.01 to 1.2×10⁻² Ohm-cm. In particular embodiments, the conductive filler (III) comprises particles exhibiting a volume resistivity (p) of from less than 1.2×10⁻² to 1.2×10⁻⁴ Ohm-cm.

In some embodiments, the conductive filler (III) comprises particles exhibiting an electrical conductivity (K) of greater than 1×10⁴ S/m, such as an electrical conductivity (K) of greater than 1×10⁵, alternatively greater than 1×10⁶ S/m.

In general, the conductive filler (III) composes the predominant amount of the composition by weight, i.e., is present in the composition in an amount of at least 50 wt. % by weight of the composition. In certain embodiments, the composition comprises the conductive filler (III) in an amount of from 60 to 83 wt. %, such as from 65 to 83, alternatively from 70 to 83, alternatively from 75 to 83, alternatively of 80 wt. %, based on the total weight of the composition. In particular embodiments, the composition comprises the conductive filler (III) in an amount of from 60 to 83, alternatively from 70 to 83, alternatively from 75 to 83, alternatively of 80 wt. %, based on the total weight of components (I), (II), and (III) composition.

In certain embodiments, the composition further comprises one or more additional components, such as one or more additives (e.g. agents, adjuvants, ingredients, modifiers, auxiliary components, etc.) aside from components (I), (II), and (III). Typically, the composition may comprise any number of additives, e.g. depending on the particular type and/or function of the same in the composition. For example, in certain embodiments, the composition may comprise one or more additives comprising, alternatively consisting essentially of, alternatively consisting of: a carrier; a filler other than component (III); a filler treating agent; a surface modifier; a surfactant; a rheology modifier; a viscosity modifier; a binder; a thickener; a tackifying agent; an adhesion promotor; a defoamer; a compatibilizer; an extender; a plasticizer; an end-blocker; a reaction inhibitor; a drying agent; a water release agent; a colorant (e.g. a pigment, dye, etc.); an anti-aging additive; a biocide; a flame retardant; a corrosion inhibitor; a catalyst inhibitor; a UV absorber; an anti-oxidant; a light-stabilizer; a catalyst, procatalyst, or catalyst generator; an initiator (e.g. a heat activated initiator, an electromagnetically activated initiator, etc.); a photoacid generator; a heat stabilizer; and the like, as well as derivatives, modifications, and combinations thereof. It is to be appreciated that additives suitable for use in the composition may be classified under numerous and different terms of art, and just because an additive is classified under such a term does not mean that it is thusly limited to that function. Moreover, some of additives may be present in a particular component of the composition (e.g. when a multi-component composition), or instead may be incorporated when forming the composition.

In some embodiments, for example, the composition comprises a carrier vehicle. The carrier vehicle is not limited and is typically selected for based on the particular silicone-acrylate polymer (I), aminosiloxane (II), and/or conductive filler selected, a desired end use of the composition, etc. In general, the carrier vehicle comprises, alternatively is, a solvent, a fluid, an oil (e.g. an organic oil and/or a silicone oil), etc., or a combination thereof.

In some embodiments, the carrier vehicle comprises a silicone fluid. The silicone fluid is typically a low viscosity and/or volatile siloxane. In some embodiments, the silicone fluid is a low viscosity organopolysiloxane, a volatile methyl siloxane, a volatile ethyl siloxane, a volatile methyl ethyl siloxane, or the like, or combinations thereof. Typically, the silicone fluid has a viscosity at 25° C. in the range of 1 to 1,000 mm²/sec. Specific examples of suitable silicone fluids include hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3, bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, hexamethyldisiloxane, heptamethyloctyltrisiloxane, hexyltrimethicone, and the like, as well as derivatives, modifications, and combinations thereof. Additional examples of suitable silicone fluids include polyorganosiloxanes with suitable vapor pressures, such as from 5×10⁻⁷ to 1.5×10⁻⁶ m²/s.

In certain embodiments, the carrier vehicle comprises an organic fluid, which typically comprises an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.), C₈-C₁₆ branched esters (e.g. isohexyl neopentanoate, isodecyl neopentanoate, etc.), and the like, as well as derivatives, modifications, and combinations thereof. Additional examples of suitable organic fluids include aromatic hydrocarbons, aliphatic hydrocarbons, alcohols having more than 3 carbon atoms, aldehydes, ketones, amines, esters, ethers, glycols, glycol ethers, acetates, alkyl halides, aromatic halides, and combinations thereof. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methylether (PGME), octyldodecyl neopentanoate, diisobutyl adipate, diisopropyl adipate, propylene glycol dicaprylate/dicaprate, octyl ether, octyl palmitate, and combinations thereof.

In some embodiments, the carrier vehicle comprises an organic solvent. Examples of organic solvents include those comprising an alcohol, such as methanol, ethanol, isopropanol, butanol, and n-propanol; a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a glycol ether, such as propylene glycol methyl ether, dipropylene glycol methyl ether, propylene glycol n-butyl ether, propylene glycol n-propyl ether, and ethylene glycol n-butyl ether; an acetate, such as ethyl acetate, butyl acetate, ethylene glycol monoethyl ether acetate, and propylene glycol methyl ether acetate; a halogenated hydrocarbon, such as dichloromethane, 1,1,1-trichloroethane, and chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof. In certain embodiments, the carrier vehicle comprises a polar organic solvent, such as a solvent compatible with water. Specific examples of such polar organic solvents utilized in certain embodiments include methanol, ethanol, 1-propanol, 2-propanol, 2-methyl-2-propanol, 2-butanone, tetrahydrofuran, acetone, and combinations thereof.

Other carrier vehicles may also be utilized. For example, in some embodiments, the carrier vehicle comprises an ionic liquid. Examples of ionic liquids include anion-cation combinations. Generally, the anion is selected from alkyl sulfate-based anions, tosylate anions, sulfonate-based anions, bis(trifluoromethanesulfonyl)imide anions, bis(fluorosulfonyl)imide anions, hexafluorophosphate anions, tetrafluoroborate anions, and the like, and the cation is selected from imidazolium-based cations, pyrrolidinium-based cations, pyridinium-based cations, lithium cation, and the like. However, combinations of multiple cations and anions may also be utilized. Specific examples of the ionic liquids typically include 1-butyl-1-methylpyrrolidinium bis(trifluoromethanesulfonyl)imide, 1-methyl-1-propylpyrrolidinium bis-(trifluoromethanesulfonyl)imide, 3-methyl-1-propylpyridinium bis(trifluoromethanesulfonyl)imide, N-butyl-3-methylpyridinium bis(trifluoromethanesulfonyl)imide, 1-methyl-1-propylpyridinium bis(trifluoromethanesulfonyl)imide, diallyldimethylammonium bis(trifluoromethanesulfonyl)imide, methyltrioctylammonium bis(trifluoromethanesulfonyl)imide, 1-butyl-3-methylimidazolium bis(trifluoromethanesulfonyl)imide, 1,2-dimethyl-3-propylimidazolium bis(trifluoromethanesulfonyl)imide, 1-ethyl-3-methylimidazolium bis(trifluoromethanesulfonyl)imide, 1-vinylimidazolium.bis(trifluoromethanesulfonyl)imide, 1-allyl imidazolium bis(trifluoromethanesulfonyl)imide, 1-allyl-3-methylimidazolium bis(trifluoromethanesulfonyl)imide, lithium bis(trifluoromethanesulfonyl)imide, and the like, as well as derivatives, modifications, and combinations thereof.

In particular embodiments, the curable composition is substantially free from, alternatively is free from, carrier vehicles, aside from components (I) and (II). In such embodiments, the silicone-acrylate polymer (I) and the aminosiloxane (II) are selected in view of each other, such that the silicone-acrylate polymer (I) and aminosiloxane (II) are miscible with each other.

In certain embodiments, the composition comprises a filler in addition to component (IIII). The additional filler is not limited, and may be any filler compatible with the other components of the composition. Examples of such additional fillers include the conductive fillers described above, as well as other fillers (e.g. nonconductive fillers). For example, reinforcing fillers, non-reinforcing fillers, or mixtures thereof may be utilized. Examples of reinforcing fillers include finely divided fillers such as high surface area fumed and precipitated silicas, including rice hull ash and, to a degree, calcium carbonate. Examples of non-reinforcing fillers include finely divided fillers such as crushed quartz, diatomaceous earths, barium sulphate, iron oxide, titanium dioxide, carbon black, talc, and wollastonite. Other fillers which might be used alone or in addition to those above include carbon nanotubes, e.g. multiwall carbon nanotubes aluminite, hollow glass spheres, calcium sulphate (anhydrite), gypsum, calcium sulphate, magnesium carbonate, clays such as kaolin, aluminum trihydroxide, magnesium hydroxide (brucite), graphite, copper carbonate, e.g. malachite, nickel carbonate, e.g. zarachite, barium carbonate, e.g. witherite and/or strontium carbonate e.g. strontianite. Additional fillers suitable for use in the composition include aluminum oxide, silicates from the group consisting of olivine group; garnet group; aluminosilicates; ring silicates; chain silicates; and sheet silicates. In certain embodiments, some fillers can be utilized to tune a thixotropic property of the composition.

In various embodiments, the composition further comprises an adhesion-imparting agent (e.g. an adhesion promotor). The adhesion-imparting agent can improve adhesion of the reaction product formed from curing the composition (i.e., the copolymer formed via cross-linking the silicone acrylate polymer (I) with the aminosiloxane (II)) to the conductive filler (III), another component of the composition, and/or to a base material being contacted during curing. In certain embodiments, the adhesion-imparting agent is selected from organosilicon compounds having at least one alkoxy group bonded to a silicon atom in a molecule. This alkoxy group is exemplified by a methoxy group, an ethoxy group, a propoxy group, a butoxy group, and a methoxyethoxy group. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl)ethyl group, a 3-(3,4-epoxycyclohexyl)propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom. The organosilicon compound of the adhesion-imparting agent generally comprises a silicon-bonded alkenyl group or silicon-bonded hydrogen atom. Moreover, due to the ability to impart good adhesion with respect to various types of base materials, the organosilicon compound of the adhesion-imparting agent generally comprises at least one epoxy group-containing monovalent organic group in a molecule. These type of organosilicon compounds are exemplified by organosilane compounds, organosiloxane oligomers and alkyl silicates, as understood by those of skill in the art. Molecular structures of the organosiloxane oligomers and/or alkyl silicate are exemplified by a linear chain structure, partially branched linear chain structure, branched chain structure, ring-shaped structure, and net-shaped structure, where the linear chain structure, branched chain structure, and net-shaped structure are typical. Specific organosilicon compounds for use in or as the adhesion-imparting agent are exemplified by silane compounds such as 3-glycidoxypropyltrimethoxysilane, 2-(3,4-epoxycyclohexyl)-ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxy group and at least one silicon-bonded alkenyl group in the molecule; and methyl polysilicate, ethyl polysilicate, and epoxy group-containing ethyl polysilicate.

In certain embodiments, the composition comprises an accelerator and/or a plasticizer, such as benzyl alcohol, salicylic acid, and/or tris-2,4,6-dimethylaminomethyl phenol.

The one or more of the additives can be present as any suitable weight percent (wt. %) of the composition, such as in an amount of from 0.01 wt. % to 65 wt. %, such as from 0.05 to 35, alternatively from 0.1 to 15, alternatively from 0.5 to 5 wt. %. In these or other embodiments, one or more of the additives can be present in the composition in an amount of 0.1 wt. % or less, alternatively of 1, 2, 3, 4, 5, 6, 7, 8, 9, 10, 11, 12, 13, 14, or 15 wt. %, or more of the composition. One of skill in the art can readily determine a suitable amount of a particular additive depending, for example, on the type of additive and the desired outcome.

In certain embodiments, the composition is substantially free from, alternatively is free from, a reaction catalyst or promotor (i.e., a compound which exhibits catalytic and/or promoting activity with respect to the cross-linking reaction of components (I) and (II) or otherwise curing of the composition), other than components (I) and (II). In these or other embodiments, the composition is substantially free from, alternatively is free from, a carrier vehicle, i.e., other than components (I) and (II) (e.g. when one or both of the components (I) and (II) is capable of acting as a carrier vehicle). In these or other embodiments, the composition is substantially free from, alternatively is free from an electrically conductive filler other than component (III). In these or other embodiments, the composition is substantially free from, alternatively is free from a bleed suppression agent other than components (I), (II), and (III). In particular embodiments, the composition is substantially free from, alternatively is free from, each of the reaction catalyst or promotor, carrier vehicle, electrically conductive filler, and bleed suppression agent, other than components (I), (II), and (III) (e.g. when one of such component exhibits an activity similar to a reaction catalyst or promotor, carrier vehicle, electrically conductive filler, and/or bleed suppression agent).

The composition may be prepared using any method for preparing curable compositions, which are generally known in the art. In general, the composition is prepared by combining together components (I), (II), and (III), optionally with any additional components being utilized. The components may be combined in any order, simultaneously, or any combinations thereof (e.g. in various multi-part compositions which are eventually combined with one another). Likewise, the composition may be prepared in batch, semi-batch, semi-continuous, or continuous processes, unless otherwise noted herein. Typically, once combined, the components of the composition are homogenized, e.g. via mixing, which may be performed by any of the various techniques known in the art using any equipment suitable for the mixing. Examples of suitable mixing techniques generally include ultrasonication, dispersion mixing, planetary mixing, three roll milling, etc. Examples of mixing equipment include agitated batch kettles for relatively high-flowability (low dynamic viscosity) compositions, ribbon blenders, solution blenders, co-kneaders, twin-rotor mixers, Banbury-type mixers, mills, extruders, etc., which may be batch-type or continuous compounding-type equipment, and utilized alone or in combination with one or more mixers of the same or different type.

A cured product formed from the composition is also provided. In general, the cured product is formed by curing the composition, i.e., by cross-linking the silicone-acrylate polymer (I) with the aminosiloxane (II) in the presence of the conductive filler (III). The cross-linking reaction may thus be characterized as a “curing” reaction, with the resulting composition (i.e., including the copolymer and the conductive filler (III)) being the cured product of the composition, or a component thereof. As such, the cured product may be referred to as a cured composite, or more simply as the composite. One of skill in the art will readily appreciate that the structure, molecular composition, and physical properties of the copolymer, and thus the composite comprising the same, will be influenced by the particular components of the composition (i.e., the silicone-acrylate polymer (I) selected, the aminosiloxane (II) selected, and any optional components utilized). Moreover, the composite may be further defined as a conductive composite, adhesive, etc., depending on the formulation of the composition and the curing conditions utilized to prepare the composite.

The particular method(s) of curing the composition are not particularly limited, and may include any method and/or technique of curing known by those of skill in the art compatible with the components of the composition described above. Examples of curing methods and/or technique include photocuring, moisture curing, cross-linking, etc. In general, curing the composition includes cross-linking the silicone-acrylate polymer (I) with the aminosiloxane (II) as described above. However, other curing methods and/or techniques may also be utilized, e.g. in conjunction with the aforementioned cross-linking, such as when the composition comprises other cure-compatible functionality.

In certain embodiments, curing the composition comprises heating the composition at, or to, an elevated temperature, e.g. to promote cross-linking of the silicone-acrylate polymer (I) with the aminosiloxane (II). The elevated temperature, which may alternatively be referred to as the curing temperature of the composition, will be selected and controlled depending on the particular silicone-acrylate polymer (I) and/or the aminosiloxane (II) to be reacted, the type, nature, and amount of the conductive filler (III) present in the composition, the conditions under which the curing is performed (e.g. whether under ambient or controlled conditions, whether the composition is disposed on a substrate during curing, etc.). Accordingly, the curing temperature will be selected by one of skill in the art in view of the reaction conditions and parameters selected and the description herein. The curing temperature is typically from 23 to 200° C., such as from greater than ambient temperature (e.g. greater than 25° C.) to 200° C., alternatively greater than 25 to 180, alternatively greater than 25 to 165, alternatively greater than 25 to 150, alternatively from 30 to 150, alternatively from 50 to 150, alternatively from 70 to 150, alternatively from 85 to 150, alternatively from 100 to 150, alternatively from 120 to 150° C. In certain embodiments, the curing temperature is selected and/or controlled based on the boiling point of any one solvent or volatile diluent, such as when utilizing refluxing conditions.

In general, curing speed of the composition (i.e., of at least components (I) and (II), in the presence of component (III)) increases: i) as the curing temperature increases; ii) as relative epoxy and/or amine group content increases (i.e., in the silicone-acrylate polymer (I) and/or the aminosiloxane (II), respectively); and iii) as a relatively/comparatively less sterically hindered silicone-acrylate polymer (I) and/or aminosiloxane (II) is utilized. In exemplary embodiments, the cure time (i.e., cross-linking time by visual inspection and/or via rheometric monitoring) of the composition is from <5 minutes to >10 days, depending on the curing temperature and particular selections for the silicone-acrylate polymer (I) and the aminosiloxane (II).

In certain embodiments, the composition may be characterized as an adhesive composition, and the cured product as an adhesive. In general, the adhesive is conductive owing to the conductive filler (III) utilized in the composition. As such, the adhesive may be further defined as a conductive adhesive. The aspects of the various embodiments described above provide the adhesive with improved performance characteristics, such as with respect to bleed, conductivity, adhesiveness, etc.

In certain embodiments, the adhesive exhibits a bleed rate of less than 20 μm/min. In some such embodiments, the adhesive exhibits a bleed rate of less than 15 μm/min, such as less than 12, alternatively less than 10, alternatively less than 8, alternatively less than 6, alternatively less than 5 μm/min. The bleed rate of the adhesive may be measured according to the Bleed Test Method set forth and described below.

In particular embodiments, the adhesive exhibits a volume resistivity (p) of less than 0.012 Ohm-cm, such as from less than 0.0012, alternatively less than 0.00012 Ohm-cm. In particular embodiments, the adhesive exhibits a volume resistivity (p) of from less than 1.2×10⁻² to 1.2×10⁻⁴ Ohm-cm. The volume resistivity of the adhesive may be measured according to the Volume Resistivity Test Method set forth and described below.

In specific embodiments, the adhesive exhibits an adhesion strength of at least 0.4 MPa. For example, in some embodiments, the adhesive exhibits an adhesion strength of at least 0.5 MPa, such as least 0.6, alternatively at least 0.7, alternatively at least 0.8, alternatively at least 0.9, alternatively at least 1 MPa. In particular embodiments, the adhesive exhibits an adhesion strength of from 0.7 to 4 MPa. However, the adhesive may comprise any maximum adhesion strength, such as a maximum adhesion of 7 MPa, alternatively a maximum adhesion of 6 MPa, alternatively a maximum adhesion of 5 MPa. The adhesion strength of the adhesive may be measured according to the Adhesive Strength Test Method set forth and described below. It is to be appreciated that the adhesion strength of the adhesive may vary, e.g. between different substrates, cure conditions, etc. As such, the adhesion strength values and ranges above may apply to the properties of the adhesive with respect to but one particular application (e.g. when utilized with respect to a specific metal substrate (e.g. Al, Ni—Cu, Alclad, etc.), or, alternatively, to any number of applications. For example, in certain embodiments, the adhesive is free from an adhesion promoter (i.e., aside from components (I), (II), and (III), and exhibits an adhesion strength in accordance with the values and ranges above. Accordingly, it will be appreciated that, in embodiments where the adhesive comprises an adhesion promoter, the adhesive may comprise an adhesion strength in the upper portions of the ranges above, or even exceeding such ranges.

It is to be appreciated that the properties described above with respect to the adhesive may apply equally to other forms of the composition and cured product thereof.

The composition may be utilized to prepare a composite article, i.e., an article comprising the cured product disposed on a substrate. For example, the composite article may be formed by disposing the composition on the substrate (e.g. as an already-prepared curable composition, or in a step-wise fashion to prepare the curable composition in-situ on the substrate), and curing the composition to give the cured product on the substrate, thereby preparing the composite article. In this fashion, the composition is typically used to prepare a layer on the substrate, such as a conductive layer.

The composition may be disposed or dispensed on the substrate in any suitable manner (e.g. via spraying, brushing, draw-down, roll-coating, etc.). Typically, the composition is applied in wet form via a wet coating technique. In certain embodiments, the composition may be applied by one of the following techniques: i) spin coating; ii) brush coating; iii) drop coating; iv) spray coating; v) dip coating; vi) roll coating; vii) flow coating; viii) slot coating; ix) gravure coating; x) Meyer bar coating; xi) printing; or xii) a combination of any two or more of i) to xi). Typically, disposing the composition on the substrate results in a wet deposit on the substrate, which is subsequently cured to give the composite article as a coated substrate comprising a layer/film of the cured product as a coating.

The composition can be disposed or otherwise applied onto the substrate in any amount. For example, the composition may be applied in an amount sufficient to achieve a nominal dry film thickness (DFT) of at least 1 mil, alternatively at least 2 mils, alternatively at least 2.5 mils, alternatively at least 3 mils, where 1 mil equals 1/1000 of an inch.

The composition can be cured on the substrate at room temperature or at an elevated temperature (e.g. such as the elevated temperature described above with respect to the curing method), such as in a forced air oven or with other types of heating sources. For example, the substrate may comprise an integrated heat source (e.g. a hot plate). The cured product may be physically and/or chemically bonded to the substrate, or instead may be separable from the substrate, depending on the particular substrate and components of the composition utilized.

The substrate of the composite article is not limited, and may be any substrate on which the composition may be disposed. Examples of substrates generally include plastics (e.g. thermoplastics and/or thermosets), silicones, woods, metals (e.g. aluminum, steel, galvanized sheeting, tin-plated steel, etc.), concretes, glass, ceramics, composites, cellulosics (e.g. paper, such as Kraft paper, polyethylene coated Kraft paper (i.e., PEK coated paper), thermal paper, regular papers, etc.), cardboards, paperboards, primed or painted surfaces, and the like, as well as combinations thereof. Specific examples of suitable plastic substrates generally include thermoplastic and/or thermosetting resins, such as polyamides (PA); polyesters such as polyethylene terephthalates (PET), polybutylene terephthalates (PBT), polytrimethylene terephthalates (PTT), polyethylene naphthalates (PEN), and liquid crystalline polyesters; polyolefins such as polyethylenes (PE), polypropylenes (PP), and polybutylenes; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones; polyvinyl alcohols (PVA); polyetheretherketones (PEEK); polyetherketoneketones (PEKK); polyarylates (PAR); polyethernitriles (PEN); phenolic resins; phenoxy resins; celluloses such as triacetylcellulose, diacetylcellulose, and cellophane; fluorinated resins, such as polytetrafluoroethylenes; thermoplastic elastomers, such as polystyrene types, polyolefin types, polyurethane types, polyester types, polyamide types, polybutadiene types, polyisoprene types, and fluoro types; and copolymers, and combinations thereof. However, it is to be appreciated that substrates other than those listed above may also be utilized to prepare the composite article, e.g. via coating and curing the composition on such other substrates.

Additionally, the substrate may have a continuous or non-continuous shape, size, dimension, surface roughness, and/or other such characteristics. In some embodiments, the substrate may have a softening point temperature at or below the elevated temperature, such that curing the composition at the elevated temperature increase the mechanical bonding of the cured product to the substrate.

The substrate is exemplified by, for example, a component of a functional device. The particular type and nature of the functional device is not particular limited, and may be any kind of optical, electrical, and/or electronic device, such that the component may comprise, or be utilized in devices containing, a waveguide, electrical circuit, electrode, etc. Particular examples of functional devices include: optical devices; photoelectric devices; photo mechanic devices; photomagnetic devices; electrical and/or electronic devices; electro-optical devices; mechanical devices; electromechanical devices including a micro-electromechanical system; magnetic devices; photo-electro-magnetic devices; mechanomagnetic devices; thermal devices; thermo-mechanical devices; thermo-optical devices; thermo-electric and/or thermo-electronic devices; thermo-magnetic devices; and the like, as well as derivatives, modifications, and combinations thereof. As will be appreciated by those of skill in the art, the cured product and/or composite article may also be a component of a functional device, such as any of those described above.

It is to be appreciated that the term “polymer” is utilized herein in the conventional sense to generally denote a compound comprising repeating units (i.e., monomeric units), which may be prepared by reacting (i.e., polymerizing) monomers, whether of the same or a different type than one another. The term polymer thus encompasses the terms “homopolymer,” which term denotes polymers comprising but one type of monomeric unit, “interpolymer,” which term denotes polymers comprising two different types of monomeric units, as well as “terpolymer,” which term denotes polymers comprising three different types of monomeric units. It is also to be appreciated that the term “copolymer” is also utilized herein in the conventional sense to denote a polymer comprising at least two different types of monomeric units, such that the term copolymer encompasses interpolymers, terpolymers, etc. As such, the term polymer also encompasses copolymers of all forms, including random, block, co-block, etc.

It is also to be understood that, although a polymer is often referred to as comprising or being “made of” one or more specified monomers, “based on,” “formed from,” or “derived from” a specified monomer or monomer type, “containing” a specified monomer content or proportion of a specified monomer, in this context the term “monomer” is understood to be referring to the monomeric unit in the polymer itself, i.e., the polymerized remnant of the specified monomer utilized in preparing the polymer, or a unit that could be so prepared, and not to the unpolymerized monomer species. As such, as used herein, polymers are generally referred to has having monomeric units in the polymerized form, which each correspond to an unpolymerized monomer (i.e., even if such monomer was not used to prepare the particular monomeric unit denoted, such as when an oligomer is utilized to prepare the specifies polymer.).

In any of the polymers described above, it is also to be understood that that trace amounts of impurities can be incorporated into or otherwise present in the polymer structure without changing the characterization of the polymer itself, which will generally be classified based on an average monomeric unit formula (i.e., excluding trace amounts of impurities from, for example, catalyst residues, initiators, terminators, etc., which may be incorporated into and/or within the polymer).

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

The following examples, illustrating embodiments of this disclosure, are intended to illustrate and not to limit the invention. Unless otherwise noted, all reactions are carried out under air, and all solvents, substrates, and reagents are purchased or otherwise obtained from various commercial suppliers and utilized as received.

The following equipment and characterization procedures/parameters are used to evaluate various physical properties of the compounds and compositions prepared in the examples below.

### Equipment

“Speedmixer” is a FlackTek DAC 150 speedmixer.

### Nuclear Magnetic Resonance Spectroscopy (NMR)

Nuclear magnetic resonance (NMR) analysis is conducted on a Varian Unity INOVA 400 (400 MHz) spectrometer, using a silicon-free 10 mm tube and appropriate solvent (e.g. CDCl₃). Chemical shifts for spectra are referenced to internal protio solvent resonance (¹H: CDCl₃; ²⁹Si: tetramethylsilane).

### Gel Permeation Chromatography (GPC)

Gel permeation chromatography (GPC) analysis is conducted on an Agilent 1260 Infinity II chromatograph with an Agilent refractive index detector using GPC/SEC software and equipped with PLgel 5 μm Mixed-C columns (300×7.5 mm; Polymer Laboratories) preceded by a PLgel 5 μm guard column. Analysis is performed using tetrahydrofuran (THF) mobile phase at a nominal flow rate of 1.0 mL/min at 35° C., with samples dissolved in THF (5 mg/mL), and optionally filtered through a 0.2 μm PTFE syringe filter, prior to injection. Calibration is performed using narrow polystyrene (PS) standards covering the range of 580 to 2,300,000 g/mol fit to a 3rd order polynomial curve.

### Dynamic Viscosity (DV)

Viscosity measurements are performed on an Anton-Paar Physica MCR 301 rheometer fitted with a 25 mm stainless steel cone-in-plate fixture (CP 25, 1.988″ cone angle with 104 μM truncation) at an operating temperature of 25° C. using the Expert flow curve steady state control method available in the accompanying software package (Rheoplus 32 V3.40). A shear rate sweep from 0.1 to 500 s⁻¹ is performed and values at a frequency of 10 rad/sec are reported in centipoise (cP).

### Bleed Test Method

Measurements of bleed are performed using a Keycene VHX 2000 digital optical microscope with magnifications ranging from 20× to 50×, according to the following Bleed Test Method:

A 5 cm×0.5 cm strip of an uncured composite material (sample) is screen printed on the rough surface of a frosted glass microscope slide (Fisher Scientific, 3″×1″×1 mm). The slide is immediately placed under the microscope and an image of the printed composite material is recorded. The composite material is allowed to sit at room temperature for 60 minutes, and then another image is recorded. Afterwards, some polymeric material is observed as separated from the composite, creating an appearance of a wet surface layer on the frosted glass slide. The distance between the edge of the printed composite and the bleed front is measured 5 times for each side of the printed material using the built-in measurement feature of the microscope, and the values averaged to give a bleed distance in μm. A bleed rate in μm/min is then determined by recording and comparting additional bleed distances over a period of time.

### Volume Resistivity Test Method

Volume resistivity analysis is conducted using a 4-point-probe instrument (GP 4-TEST Pro; GP Solar, GmbH) equipped with a line resistance probe head, according to the following Volume Resistivity Test Method:

An aliquot of uncured composite material (sample) is deposited on a 4″×4″ glass slide by screen printing through apertures (5 mm×60 mm×0.25 mm) to form a uniform strip having an area of 5 mm×60 mm (300 mm²). The printed material is then cured at 150° C. (cure time=material dependent; 1 hr (comparative examples) to 4 hr (examples)) to give a conductive strip as a cured layer on the slide, and the thickness of the cured layer determined using a micrometer (Ono Sokki digital indicator EG-225). The line resistance probe head is utilized to measure electrical resistance through a 5 cm distance along the conductive strip, and the resistivity of the cured sample calculated using the equation (ρ=R(W×T/L) where ρ (rho) is the volume resistivity in Ohm cm, R is the resistance in Ohms of the cured composite measured between two inner probe tips spaced 5 cm apart, W is the width of the cured layer in cm, T is the thickness of the cured layer in cm, and L is the length of the cured layer between the two inner probes in cm.

### Adhesion Strength Test Method, Lap Shear Adhesion

The adhesion of a sample is tested using a lap shear test, with measurements of tensile strength performed on a Tensile Tester (Instron, Model 5566), according to the following Adhesion Strength Test Method:

Lap shear panels (bare aluminum, Ni—Cu, Alclad) of dimensions 0.040″×1″×3″ are wiped clear with a cleaning wipe (Kimwipe) and isopropyl alcohol, placed in an oven at 150° C. for 10 minutes to ensure complete solvent evaporation, and then allowed to cool to room temperature. The panels are grouped into five pairs, and a first panel in each pair is marked 1″ from an end of the panel. An aliquot of uncured composite material (sample; ˜2 g) is applied to the first panels in the 1″ area between the marking and the end of the panel from which the marking was measured. A portion of glass beads (Potter's Industries Inc.; 0.0098″ max diameter; ˜10 mg) is applied on top of the composite to establish a bond line, and then the second panels of each pair is gently pressed on top of the portion of the corresponding first panel to form an assembly, which is held together and in place with binder clips. The assemblies are placed into an oven at 150° C. for 4 hours to cure the composite material, and then cooled to room temperature overnight. The assemblies are then analyzed on the tensile tester using a 10 KN load cell, 60 psi clamp pressure, and a pull rate of 2 in/min, with tensile strength measurements recorded for each of the 5 prepared lap shears averaged to give an adhesion strength value (MPa).

The various components utilized in the Examples are set forth in Table 1 below.

TABLE 1
Components/Compounds Utilized

| Component | Description |
|---|---|
| Organosilicon Monomer (M1) | [bis(trimethylsiloxy)methylsiloxy]-propyl methacrylate |
| Organosilicon Monomer (M2) | A (meth)acryloxy-functional organosilicon compound having formula: 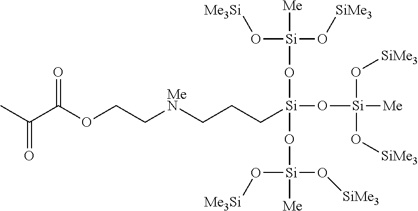 [SMILES: CC(=O)C(=O)OCCN(C)CCC[Si](O[Si](C)(O[Si](C)(C)C)O[Si](C)(C)C)(O[Si](C)(O[Si](C)(C)C)O[Si](C)(C)C)O[Si](C)(O[Si](C)(C)C)O[Si](C)(C)C] |
| Organosilicon Monomer (M3) | A 800-1000 Mw mono-(meth)acrylate-terminated polydimethylsiloxane having general formula: 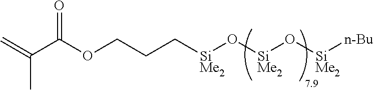 |
| Organosilicon Monomer (M4) | A mono-(meth)acrylate-terminated polydimethylsiloxane having general formula: 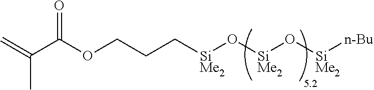 |
| Organosilicon Monomer (M5) | A (meth)acryloxy-functional organosilicon compound having formula: 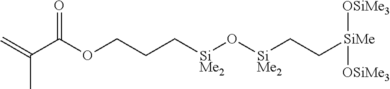 |
| Silicone-acrylate (SA-1) | An epoxide-functional silicone-acrylate polymer prepared in Preparation Example 1 below, having the general formula: 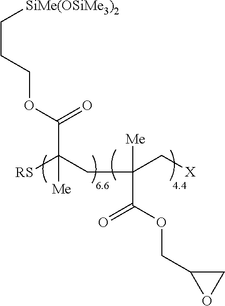 |
| Silicone-acrylate (SA-2) | An epoxide-functional silicone-acrylate polymer prepared in Preparation Example 2 below, having the general formula: 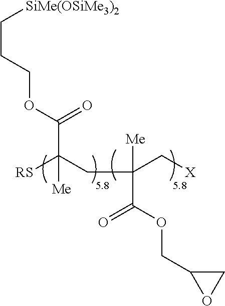 |
| Silicone-acrylate (SA-3) | An epoxide-functional silicone-acrylate polymer prepared in Preparation Example 3 below, having the general formula: 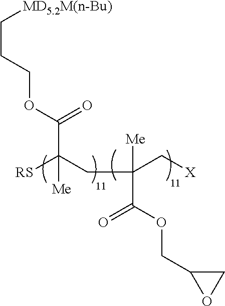 |
| Silicone-acrylate (SA-4) | An epoxide-functional silicone-acrylate polymer prepared in Preparation Example 4 below, having the general formula: 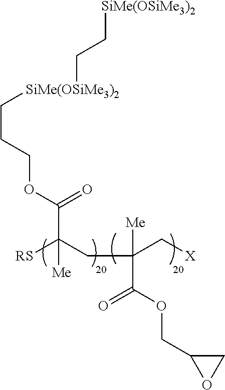 |
| Silicone-acrylate (SA-5) | An epoxide-functional silicone-acrylate polymer prepared in Preparation Example 5 below, haying the general formula: 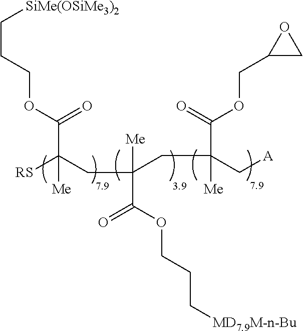 |
| Silicone-acrylate (SA-6) | An epoxide-functional silicone-acrylate polymer prepared in Preparation Example 6 below, haying the general formula: 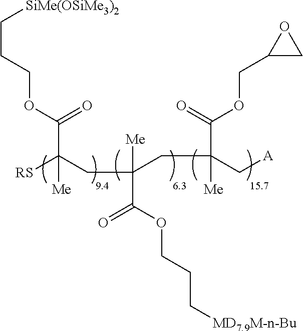 |
| Silicone-acrylate (SA-7) | An epoxide-functional silicone-acrylate polymer prepared in Preparation Example 7 below, haying the general formula: 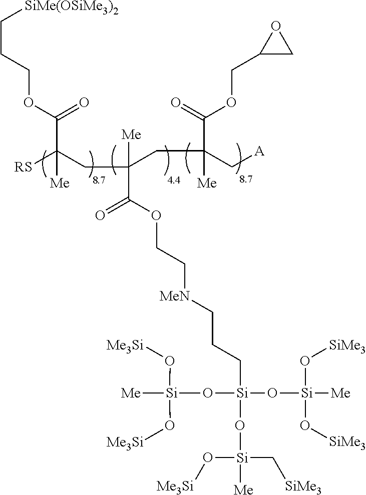 |
| Aminosiloxane (AS-1) | A Telechelic aminosiloxane having formula: 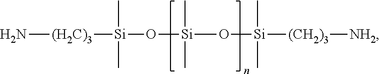 where n = 9; a viscosity of 25 cP; and a Mw of 1000. |
| Aminosiloxane (AS-2) | A Telechelic aminosiloxane having formula: 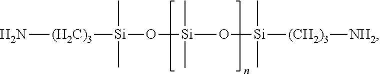 where n = 37; a viscosity of 55 cP; and a Mw of 3000. |
| Conductive Filler 1 | Ag flake |
| Polysiloxane 1 | A vinyl terminated siloxane having formula: 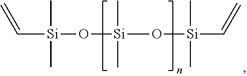 where n = 177; a viscosity of 380 cP; and a Mw of 13000. |
| Crosslinker 1 | Trimethyl-endcapped hydrido-methyl siloxane (MD_{37.1} D^{H}_{37.4}M) |
| Crosslinker 2 | Trimethyl-endcapped hydrido-methyl siloxane (MD_{3.2}D^{H}_{5.8}M) |
| Pt Catalyst 1 | Microencapsulated Pt catalyst |

General Procedure 1: Preparing Epoxide-Functional Silicone-Acrylate Polymers

Toluene (20 g) is added to an oven-dried 500 mL 4-neck round bottomed flask, equipped with stir shaft, condenser, thermocouple port, addition ports, and a heating mantle. A mixture of Organosilicon Monomer (M1, 87 g), glycidyl (meth)acrylate (GMA; 24 g), and n-dodecanethiol (CTA; 8 g) (collectively, the “monomer blend”) is prepared and split into two plastic syringes with Luer Lock connectors, which are equipped with a feed line into the flask and connected to a syringe pump. A mixture of benzoyl peroxide (BPO; 4.04 g) and toluene (40 g) (the “initiator blend”) is added to another plastic syringe with a Luer Lock connector, which is equipped with a feed line into the flask and connected to a syringe pump. The flask is heated to reach a target temperature (110° C.) with stirring, at which time a feed of the monomer blend is initiated (rate: 2.5 g/min; duration: 40 m). After a 5 m delay, a feed of the initiator blend is initiated (duration: 120 min), and the reaction monitored via ¹H NMR. After completion of both feeds, the reaction mixture is maintained at the target temperature (110° C.) with stirring for 1 h, and then allowed to cool to room temperature (˜23° C.) to give a reaction product comprising an epoxide-functional silicone-acrylate polymer (SA-1), which is isolated via distillation and characterized according to the procedures above.

### Preparation Examples 1-7: Epoxide-Functional Silicone-Acrylate Polymers

Silicone-acrylate polymers (SA-1)-(SA-7) are prepared according to the procedure set forth in General Procedure 1 above, using various acryloxy-functional organosilicon compounds ((M1)-(M5)), to give Preparation Examples 1-7. The particular components and parameters of Preparation Examples 1-7 are set forth in Table 2 below. Once prepared, the silicone-acrylate polymers (SA-1)-(SA-7) are characterized according to the procedures above, the results of which are also set forth in Table 2 below.

TABLE 2
Components, Parameters, & Silicone-Acrylate Polymers of Preparation Examples 1-7

| Prep. Example: | PE 1 | PE 2 | PE 3 | PE 4 | PE 5 | PE 6 | PE 7 |
|---|---|---|---|---|---|---|---|
| AFOSC (M) (i): | M1 | M1 | M4 | M5 | M1 | M1 | M1 |
| Amount (i) (wt. %): | 79 | 71 | 83 | 78 | 37 | 29 | 37 |
| AFOSC (M) (ii): | N/A | N/A | N/A | N/A | M3 | M3 | M2 |
| Amount (ii)(wt. %): | 0 | 0 | 0 | 0 | 48 | 51 | 49 |
| GMA (iii) (wt. %): | 21 | 29 | 17 | 22 | 15 | 20 | 15 |
| (i):(ii):(iii) (mol): | 6:0:4 | 5:0:5 | 5:0:5 | 5:0:5 | 4:2:4 | 3:2:5 | 4:2:4 |
| BPO (mol %): | 1.5 | 1.5 | 6 | 6 | 6 | 6 | 8 |
| CTA (mol %): | 7 | 7 | 10 | 10 | 10 | 10 | 10 |
| Temperature (° C.): | 100 | 100 | 110 | 110 | 110 | 110 | 110 |
| Yield (%): | 94 | 94 | 94 | 93 | 94 | 96 | 88 |
| Purity (%): | 99 | 99 | >99 | >99 | >99 | >99 | 99 |
| SA Polymer: | SA-1 | SA-2 | SA-3 | SA-4 | SA-5 | SA-6 | SA-7 |
| Mp: | 3520 | 3402 | 14292 | 10569 | 11886 | 11688 | 8784 |
| Mn: | 2920 | 2847 | 9260 | 13054 | 7405 | 11191 | 8334 |
| Mw: | 4143 | 4088 | 18849 | 33923 | 12512 | 15302 | 11641 |
| Mz: | 5688 | 5695 | 34142 | 87086 | 18278 | 22188 | 17343 |
| PD: | 1.42 | 1.44 | 2.04 | 2.6 | 1.69 | 1.37 | 1.397 |
| Viscosity (cP): | 11528 | 36275 | 1105 | 15708 | 1670 | 3352 | 34563 |

### Comparative Examples 1 & 2

A 20 g dental cup is charged with Conductive Filler 1 (16 g). Polysiloxane 1 (3.64 g) is then added, and the resulting composition gently mixed by hand using a spatula and then via speedmixer (2000 rpm; 20 s). Crosslinker 1 (0.15 g) is then added, and the resulting composition is mixed via speedmixer (2000 rpm; 20 s). Pt Catalyst 1 (0.20 g; 10 ppm Pt) is then added, and the resulting composition is mixed via speedmixer (2000 rpm; 20 s). The composition is then degassed in a vacuum chamber connected to a rotary vane pump (1 Torr; ˜5 min), and then subjected to gentle shear on the speedmixer (2000 rpm; 10 s) to give a homogeneous curable composition (Comparative Composition 1). The curable composition is screen printed and then cured at 150° C. for 1 hour to prepare a cured composite (Comparative Composite 1).

The above procedure is repeated using Crosslinker 2 to give another homogeneous curable composition (Comparative Composition 2), which is screen printed and then cured at 150° C. for 1 hour to prepare another cured composite (Comparative Composite 2). Particular parameters of Comparative Examples 1-2 are set forth in Table 3 below.

Once prepared, Comparative Composites 1 & 2 are assessed for resistivity, bleed, and adhesion strength according to the procedures above. The results of these assessments are also set forth in Table 3 below.

TABLE 3
Parameters and Properties of Comparative Examples 1 & 2

| Comparative Example: | Comp. Ex. 1 | Comp. Ex. 2 |
|---|---|---|
| Crosslinker 1 (wt. %): | 0.8 | 0 |
| Crosslinker 2 (wt. %): | 0 | 0.7 |
| Polysiloxane 1 (wt. %): | 18.2 | 18.3 |
| Pt Catalyst 1 (wt. %): | 1 | 1 |
| Conductive Filler 1 (wt. %): | 80 | 80 |
| Volume Resistivity (Ohm cm): | 6.21 ± 0.24 × 10⁻⁴ | Non conductive |
| Bleed (μm/min): | 25 ± 2.1 | 27 ± 2.6 |
| Al Adhesion Strength (MPa): | 0.10 ± 0.05 | n.d. |
| Ni—Cu Adhesion Strength (MPa): | n.d. | n.d. |
| Alclad Adhesion Strength (MPa): | n.d. | n.d. |
| Adhesion Failure Mode: | Adhesive | Adhesive |

### General Procedure 2: Preparing a Curable Composition

A silicone-acrylate polymer (SA-7, 2.95 g) and an aminosiloxane (AS-1, 1.05 g) are combined in a 20 g dental cup to form a composition having a target epoxy:amine equivalent weight ratio (1:1), which is mixed via speedmixer (2000 rpm; 20 s) to form a homogeneous solution. Conductive Filler 1 (16 g) is then added to the dental cup, and the resulting composition gently mixed by hand using a spatula and then twice via speedmixer (2000 rpm; 20 s). The composition is then degassed in a vacuum chamber connected to a rotary vane pump (1 Torr; ˜5 min), and then subjected to gentle shear on the speedmixer (1000 rpm; 10 s) to give a homogeneous curable composition.

### Examples 1-42: Curable Compositions

Curable compositions are prepared according to the procedure set forth in General Procedure 2 above, using one of the silicone-acrylate polymers (SA-1)-(SA-8) from Preparation Examples 1-8 as Component (I), and aminosiloxane (AS-1) or (AS-2) as Component (II), and Conductive Filler 1 as Component (III), with Components (I) & (II) utilized at particular epoxy:amine equivalent weight ratios, to give Examples 1-42. The particular components and parameters of Examples 1-42 are set forth in Tables 4 and 5 below.

TABLE 4
Components and Parameters of Examples 1-21

| | | | Epoxy:Amine | Amount (I) | Amount (II) | Amount (III) |
|---|---|---|---|---|---|---|
| Example | Comp. (I) | Comp. (II) | eq. wt. ratio | (wt. %) | (wt. %) | (wt. %) |
| Ex. 1 | SA-1 | AS-1 | 1:1 | 14.7 | 5.3 | 80 |
| Ex. 2 | SA-1 | AS-1 | 1:1.5 | 13 | 7 | 80 |
| Ex. 3 | SA-1 | AS-1 | 1:2 | 11.7 | 8.3 | 80 |
| Ex. 4 | SA-1 | AS-1 | 1:2.5 | 10.6 | 9.4 | 80 |
| Ex. 5 | SA-2 | AS-1 | 1:1 | 13.5 | 6.5 | 80 |
| Ex. 6 | SA-2 | AS-1 | 1:1.5 | 11.6 | 8.4 | 80 |
| Ex. 7 | SA-2 | AS-1 | 1:2 | 10.2 | 9.8 | 80 |
| Ex. 8 | SA-2 | AS-1 | 1:2.5 | 9 | 11 | 80 |
| Ex. 9 | SA-3 | AS-2 | 1:1 | 10.6 | 9.4 | 80 |
| Ex. 10 | SA-3 | AS-2 | 1:0.5 | 13.8 | 6.2 | 80 |
| Ex. 11 | SA-3 | AS-2 | 1:1.5 | 8.6 | 11.4 | 80 |
| Ex. 12 | SA-3 | AS-2 | 1:2 | 7.2 | 12.8 | 80 |
| Ex. 13 | SA-3 | AS-2 | 1:2.5 | 6.2 | 13.8 | 80 |
| Ex. 14 | SA-4 | AS-1 | 1:1 | 14.6 | 5.4 | 80 |
| Ex. 15 | SA-4 | AS-1 | 1:0.5 | 16.9 | 3.1 | 80 |
| Ex. 16 | SA-4 | AS-1 | 1:1.5 | 12.9 | 7.1 | 80 |
| Ex. 17 | SA-4 | AS-1 | 1:2 | 11.6 | 8.4 | 80 |
| Ex. 18 | SA-4 | AS-1 | 1:2.5 | 10.4 | 9.6 | 80 |
| Ex. 19 | SA-5 | AS-1 | 1:1 | 15.9 | 4.1 | 80 |
| Ex. 20 | SA-5 | AS-1 | 1:0.5 | 17.7 | 2.3 | 80 |
| Ex. 21 | SA-5 | AS-1 | 1:1.5 | 14.5 | 5.5 | 80 |

TABLE 5
Components and Parameters of Examples 1-42

| | | | Epoxy:Amine | Amount (I) | Amount (II) | Amount (III) |
|---|---|---|---|---|---|---|
| Example | Comp. (I) | Comp. (II) | eq. wt. ratio | (wt. %) | (wt. %) | (wt. %) |
| Ex. 22 | SA-5 | AS-1 | 1:2 | 13.2 | 6.8 | 80 |
| Ex. 23 | SA-5 | AS-2 | 1:1 | 11.1 | 8.9 | 80 |
| Ex. 24 | SA-5 | AS-2 | 1:0.7 | 12.5 | 7.5 | 80 |
| Ex. 25 | SA-5 | AS-2 | 1:1.5 | 9.1 | 10.9 | 80 |
| Ex. 26 | SA-5 | AS-2 | 1:2 | 7.7 | 12.3 | 80 |
| Ex. 27 | SA-6 | AS-1 | 1:1 | 15 | 5 | 80 |
| Ex. 28 | SA-6 | AS-1 | 1:0.7 | 16 | 4 | 80 |
| Ex. 29 | SA-6 | AS-1 | 1:1.5 | 13.3 | 6.7 | 80 |
| Ex. 30 | SA-6 | AS-1 | 1:2 | 11.9 | 8.1 | 80 |
| Ex. 31 | SA-6 | AS-2 | 1:1 | 9.7 | 10.3 | 80 |
| Ex. 32 | SA-6 | AS-2 | 1:0.7 | 11.1 | 8.9 | 80 |
| Ex. 33 | SA-6 | AS-2 | 1:1.5 | 7.7 | 12.3 | 80 |
| Ex. 34 | SA-6 | AS-2 | 1:2 | 6.4 | 13.6 | 80 |
| Ex. 35 | SA-7 | AS-1 | 1:1 | 16 | 4 | 80 |
| Ex. 36 | SA-7 | AS-1 | 1:0.7 | 16.8 | 3.2 | 80 |
| Ex. 37 | SA-7 | AS-1 | 1:1.5 | 14.6 | 5.4 | 80 |
| Ex. 38 | SA-7 | AS-1 | 1:2 | 13.3 | 6.7 | 80 |
| Ex. 39 | SA-7 | AS-2 | 1:1 | 11.2 | 8.8 | 80 |
| Ex. 40 | SA-7 | AS-2 | 1:0.7 | 12.6 | 7.4 | 80 |
| Ex. 41 | SA-7 | AS-2 | 1:1.5 | 9.2 | 10.8 | 80 |
| Ex. 42 | SA-7 | AS-2 | 1:2 | 7.8 | 12.2 | 80 |

Once prepared, the compositions of Examples 1-42 assessed for resistivity and bleed using the Volume Resistivity Test Method and Bleed Test Method, respectively, according to the procedures above. The results of these assessments are set forth in Table 6 below.

TABLE 6
Resistivity and Bleed Assessment Results of Examples 1-42

| Example | Volume Resistivity (Ohm cm) | Bleed (μm/min) |
|---|---|---|
| Ex. 1 | 5.60 ± 0.06 × 10⁻⁴ | 4.5 ± 0.11 |
| Ex. 2 | 3.80 ± 0.14 × 10⁻⁴ | 15 ± 0.21 |
| Ex. 3 | 3.81 ± 0.10 × 10⁻⁴ | n.d. |
| Ex. 4 | 7.56 ± 0.15 × 10⁻⁴ | n.d. |
| Ex. 5 | 9.18 ± 0.22 × 10⁻³ | 4.0± 0.08 |
| Ex. 6 | 8.77 ± 0.69 × 10⁻³ | n.d. |
| Ex. 7 | 5.45 ± 0.29 × 10⁻³ | n.d. |
| Ex. 8 | 4.61 ± 0.47 × 10⁻³ | n.d. |
| Ex. 9 | 5.04 ± 0.06 × 10⁻⁴ | 20 ± 2.7 |
| Ex. 10 | 5.68 ± 0.32 × 10⁻⁴ | n.d. |
| Ex. 11 | 5.04 ± 0.43 × 10⁻⁴ | n.d. |
| Ex. 12 | 3.45 ± 0.05 × 10⁻⁴ | n.d. |
| Ex. 13 | 4.66 ± 0.29 × 10⁻⁴ | n.d. |
| Ex. 14 | 9.18 ± 0.22 × 10⁻⁴ | 4.4 ± 0.51 |
| Ex. 15 | 1.95 ±0.61 × 10⁻⁴ | n.d. |
| Ex. 16 | 2.66 ± 0.44 × 10⁻⁴ | n.d. |
| Ex. 17 | 3.79 ± 0.06 × 10⁻⁴ | n.d. |
| Ex. 18 | 5.75 ± 0.15 × 10⁻⁴ | n.d. |
| Ex. 19 | 2.08 ± 0.29 × 10⁻² | n.d. |
| Ex. 20 | 5.34 ± 0.70 × 10⁻¹ | n.d. |
| Ex. 21 | 5.20 ± 0.08 × 10⁻³ | n.d. |
| Ex. 22 | 3.24 ± 0.36 × 10⁻³ | n.d. |
| Ex. 23 | 1.86 ± 0.17 × 10⁻² | n.d. |
| Ex. 24 | 1.74 ± 0.06 × 10⁻² | n.d. |
| Ex. 25 | 1.48 ± 0.08 × 10⁻² | n.d. |
| Ex. 26 | 3.96 ± 0.30 × 10⁻² | n.d. |
| Ex. 27 | 2.95 ±0.11 × 10⁻³ | n.d. |
| Ex. 28 | 7.93 ± 0.30 × 10⁻³ | n.d. |
| Ex. 29 | 2.18 ± 0.18 × 10⁻³ | n.d. |
| Ex. 30 | 1.85 ± 0.09 × 10⁻³ | n.d. |
| Ex. 31 | 3.14 ± 0.04 × 10⁻³ | n.d. |
| Ex. 32 | 3.30 ± 0.16 × 10⁻³ | n.d. |
| Ex. 33 | 5.15 ±0.31 × 10⁻³ | n.d. |
| Ex. 34 | 1.14 ± 0.07 × 10⁻² | n.d. |
| Ex. 35 | 2.37 ± 0.63 × 10⁻⁴ | 4.3 ± 0.08 |
| Ex. 36 | 1.89 ± 0.14 × 10⁻⁴ | 3. 3± 0.11 |
| Ex. 37 | 2.36 ± 0.14 × 10⁻⁴ | 5.1 ± 0.13 |
| Ex. 38 | 2.92 ± 0.06 × 10⁻⁴ | 7.2 ± 0.26 |
| Ex. 39 | 5.01 ± 0.45 × 10⁻⁴ | n.d. |
| Ex. 40 | 3.65 ± 0.39 × 10⁻⁴ | n.d. |
| Ex. 41 | 9.58 ± 1.13 × 10⁻⁴ | n.d. |
| Ex. 42 | 1.61 ± 0.15 × 10⁻³ | n.d. |

where “n.d.” denotes a value that was not determined.

The compositions of Examples 1-42 are assessed for adhesion using the Adhesion Strength Test Method, according to the procedure above. The results of these assessments are set forth in Table 7 below.

TABLE 7
Adhesion Assessment Results of Examples 1-42

| | Al Adhesion | Ni—Cu Adhesion | Alclad Adhesion | |
|---|---|---|---|---|
| Example | Strength (MPa) | Strength (MPa) | Strength (MPa) | Adhesion Failure Mode |
| Ex. 1 | 1.02 ± 0.1 | 2.2 ± 0.08 | 2.4 ± 0.04 | Cohesive/Adhesive |
| Ex. 2 | n.d. | n.d. | n.d. | n.d. |
| Ex. 3 | n.d. | n.d. | n.d. | n.d. |
| Ex. 4 | n.d. | n.d. | n.d. | n.d. |
| Ex. 5 | n.d. | n.d. | n.d. | n.d. |
| Ex. 6 | n.d. | n.d. | n.d. | n.d. |
| Ex. 7 | n.d. | n.d. | n.d. | n.d. |
| Ex. 8 | n.d. | n.d. | n.d. | n.d. |
| Ex. 9 | n.d. | n.d. | n.d. | n.d. |
| Ex. 10 | n.d. | n.d. | n.d. | n.d. |
| Ex. 11 | n.d. | n.d. | n.d. | n.d. |
| Ex. 12 | n.d. | n.d. | n.d. | n.d. |
| Ex. 13 | n.d. | n.d. | n.d. | n.d. |
| Ex. 14 | 1.3 ± 0.1 | 1.4 ± 0.05 | 1.7 ± 0.05 | Cohesive/Adhesive |
| Ex. 15 | n.d. | n.d. | n.d. | n.d. |
| Ex. 16 | n.d. | n.d. | n.d. | n.d. |
| Ex. 17 | n.d. | n.d. | n.d. | n.d. |
| Ex. 18 | n.d. | n.d. | n.d. | n.d. |
| Ex. 19 | n.d. | n.d. | n.d. | n.d. |
| Ex. 20 | n.d. | n.d. | n.d. | n.d. |
| Ex. 21 | n.d. | n.d. | n.d. | n.d. |
| Ex. 22 | n.d. | n.d. | n.d. | n.d. |
| Ex. 23 | n.d. | n.d. | n.d. | n.d. |
| Ex. 24 | n.d. | n.d. | n.d. | n.d. |
| Ex. 25 | n.d. | n.d. | n.d. | n.d. |
| Ex. 26 | n.d. | n.d. | n.d. | n.d. |
| Ex. 27 | n.d. | n.d. | n.d. | n.d. |
| Ex. 28 | n.d. | n.d. | n.d. | n.d. |
| Ex. 29 | n.d. | n.d. | n.d. | n.d. |
| Ex. 30 | n.d. | n.d. | n.d. | n.d. |
| Ex. 31 | n.d. | n.d. | n.d. | n.d. |
| Ex. 32 | n.d. | n.d. | n.d. | n.d. |
| Ex. 33 | n.d. | n.d. | n.d. | n.d. |
| Ex. 34 | n.d. | n.d. | n.d. | n.d. |
| Ex. 35 | 0.7 ± 0.03 | 0.8 ± 0.04 | 0.8 ± 0.03 | Cohesive |
| Ex. 36 | n.d. | n.d. | n.d. | n.d. |
| Ex. 37 | n.d. | n.d. | n.d. | n.d. |
| Ex. 38 | n.d. | n.d. | n.d. | n.d. |
| Ex. 39 | n.d. | n.d. | n.d. | n.d. |
| Ex. 40 | n.d. | n.d. | n.d. | n.d. |
| Ex. 41 | n.d. | n.d. | n.d. | n.d. |
| Ex. 42 | n.d. | n.d. | n.d. | n.d. |

where “n.d.” c enotes a value that was not determined.

As shown, the curable compositions utilizing silicone-acrylate polymers containing branched silicone moieties and greater than 30 mol % GMA (e.g. 40 and 50%) and aminosiloxanes having molecular weights of from −1000 to 3000 prepare cured products with good conductivity (<0.0012 Ohm cm volume resistivity), excellent (<5 μm/min) to intermediate (<15 μm/min) bleed, and high adhesion (>1 MPa) on one or more substrates, with intermediate adhesion (>0.5 MPa) on all substrates tested and no purely adhesive failures. The curable compositions utilizing silicone-acrylate polymers with linear silicone moieties and greater than 40% mol GMA combined with aminosiloxanes having molecular weights from ˜1000 to 3000 prepare cured products with good conductivity (<0.0012 Ohm cm volume resistivity), while similar compositions using silicone-acrylate polymers with 40% GMA prepare cured products with adequate conductivity.

1. A curable composition, comprising:
(I) an epoxide-functional silicone-acrylate polymer having the following general unit formula: 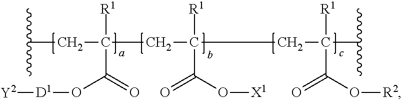
wherein: each R¹ is independently selected from H and CH₃; each R² is an independently selected substituted or unsubstituted hydrocarbyl group; each D¹ is a divalent linking group; each Y¹ is an independently selected siloxane moiety; each X¹ is an independently selected epoxide-functional moiety; subscript a≥1; subscript b≥1; subscript c≥0; and units indicated by subscripts a, b, and c may be in any order in the silicone-acrylate polymer;
(II) an aminosiloxane comprising an average of at least two amine functional groups per molecule; and
(III) a conductive filler.

2. The curable composition of claim 1, wherein in the epoxide-functional silicone-acrylate polymer (I) at least one siloxane moiety Y¹ comprises a siloxane group having general formula —Si(R³)₃, where each R³ is independently selected from R⁴ and —OSi(R⁵)₃, with the proviso that at least one R³ is —OSi(R⁵)₃; where each R⁵ is independently selected from R⁴, —OSi(R⁶)₃, and -[-D²-SiR⁴₂]ₘOSiR⁴₃; where each R⁶ is independently selected from R⁴, —OSi(R⁷)₃, and -[-D²-SiR⁴₂]ₘOSiR⁴₃; where each R⁷ is independently selected from R⁴ and -[-D²-SiR⁴₂]ₘOSiR⁴₃; where 0≤m≤100; where each D² is a divalent linking group; and where each R⁴ is independently a substituted or unsubstituted hydrocarbyl group.

3. The curable composition of claim 2, wherein in the epoxide-functional silicone-acrylate polymer (I): (i) each R³ is —OSi(R⁵)₃; (ii) each R⁴ is methyl; (iii) at least one R⁵ is —OSi(R⁶)₃ or -[-D²-SiR⁴₂]ₘOSiR⁴₃; (iv) each D² is independently O or ethylene; or (v) any combination of (i)-(iv).

4. The curable composition of claim 1, wherein in the epoxide-functional silicone-acrylate polymer (I) at least one siloxane moiety Y¹ comprises a siloxane group having the following general formula: 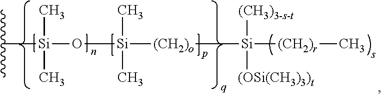
where 0≤n≤100, subscript o is from 2 to 6, subscript p is 0 or 1, subscript q is 0 or 1, subscript r is from 0 to 9, subscript s is 0 or 1, and subscript t is 0 or 2, with the provisos that subscript t is 0 when subscript s is 1, and subscript t is 2 when subscript s is 0.

5. The curable composition of claim 1, wherein in the epoxide-functional silicone-acrylate polymer (I) each siloxane moiety Y¹ is independently a siloxane group having one of the following formulas (i)-(vii): 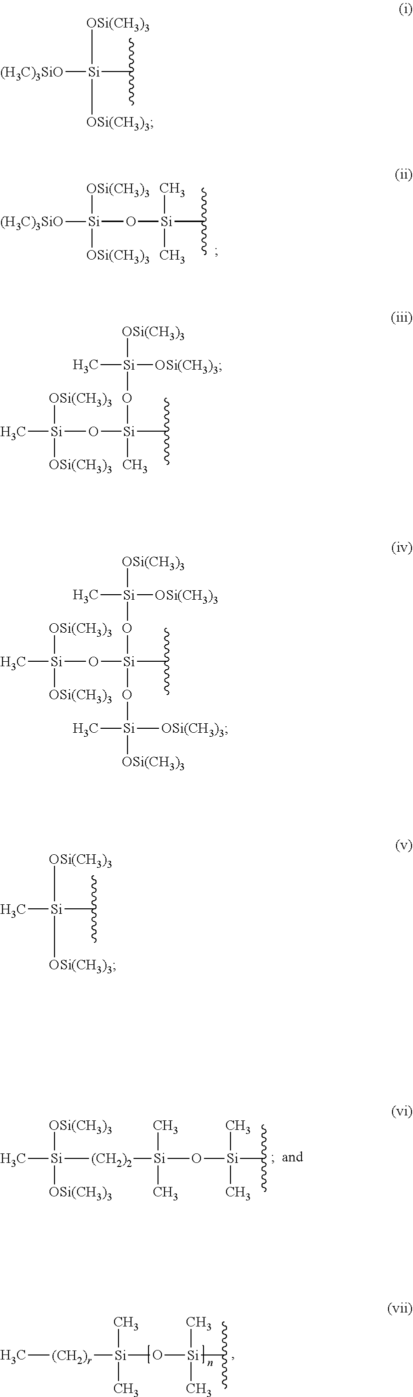
where 1≤n≤100 and subscript r is from 3 to 9.

6. The curable composition of claim 1, wherein in the epoxide-functional silicone-acrylate polymer (I) each divalent linking group D¹ comprises: (i) an independently selected linear alkylene group having from 2 to 6 carbon atoms; (ii) a tertiary amino group; or (iii) both (i) and (ii).

7. The curable composition of claim 1, wherein in the epoxide-functional silicone-acrylate polymer (I): (i) R¹ is CH₃ in each moiety indicated by subscript a; (ii) R¹ is CH₃ in each moiety indicated by subscript b; (iii) R¹ is H in each moiety indicated by subscript c; (iv) each R² is butyl; (v) each X¹ is an epoxypropyl group of formula 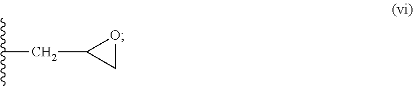 [SMILES: *CC1CO1]
subscript b is comprises at least 30% of the total units indicated by subscripts a, b, and c; or (vii) any combination of (i)-(vi).

8. The curable composition of claim 1, wherein the aminosiloxane (II) has the general average unit formula [R⁸ᵢSiO_{(4-i)/2}]ₕ, where: subscript h≥1; subscript i is independently selected from 1, 2, and 3 in each moiety indicated by subscript h, with the proviso that h+i>2; and each R⁸ is independently selected from hydrocarbyl groups, alkoxy and/or aryloxy groups, siloxy groups, and amine-functional hydrocarbon groups, with the proviso that an average of at least two R⁸ are amine-functional hydrocarbon groups per molecule.

9. The curable composition of claim 1, wherein the aminosiloxane (II) has the following general formula:
[R⁹₃SiO_{1/2}]ₓ[(H₂N-D³-)(R⁹)₂SiO_{1/2}]_{x′}[R⁹₂SiO_{2/2}]_{y}[(H₂N-D³-)(R⁹)SiO_{2/2}]_{y′}
where each R⁹ is an independently selected hydrocarbyl group; each D³ is an independently selected divalent linking group; and subscripts x, x′, y, and y′ are each mole fractions such that x+x′+y+y′=1, with the provisos that 0≤x+x′<1, 0<y+y′<1, and x′+y′>0.

10. The curable composition of claim 9, wherein: (i) each R⁹ is CH₃; (ii) each D³ is an alkylene group having from 2 to 10 carbon atoms; (iii) x is 0; (iv) y′ is 0; (v) the aminosiloxane (II) has a degree of polymerization of from 5 to 100; (vi) the aminosiloxane (II) exhibits a dynamic viscosity of less than 200 centipoise (cP) at 25° C.; (vii) the aminosiloxane (II) has a molecular weight (Mw) of from 500 to 3000 Da; (viii) the aminosiloxane (II) is miscible with the epoxide-functional silicone-acrylate polymer (I); or (ix) any combination of (i)-(viii).

11. The curable composition of claim 1, wherein the conductive filler (III): is electrically conductive; (ii) is thermally conductive; (iii) comprises inorganic particles; (iv) comprises organic particles; (v) comprises surface-treated particles; or (vi) any combination of (i)-(v).

12. The curable composition of claim 1, wherein the conductive filler (III): (i) comprises silver-coated metal particles; (ii) comprises silver-coated organic particles; (iii) comprise silver flakes; (iv) comprises a median particle size of from 0.005 to 100 m; (v) comprises an electrical conductivity (K) of 1×10⁶ S/m; or (vi) any combination of (i)-(v).

13. The curable composition of claim 1, comprising, based on the combined weights of components (I), (II), and (III): (i) from 5 to 20 wt. % of component (I); (ii) from 2 to 15 wt. % of component (II); (iii) from 65 to 83 wt. % of component (III); or (iv) any combination of (i)-(iii).

14. The curable composition of claim 1, further comprising: (i) a carrier; (ii) a filler other than component (III); (iii) a filler treating agent; (iv) a surface modifier; (v) a surfactant; (vi) a rheology modifier; (vii) a viscosity modifier; (viii) a binder; (ix) a thickener; (x) a tackifying agent; (xi) an adhesion promotor; (xii) a defoamer; (xiii) a compatibilizer; (xiv) an extender; (xv) a plasticizer; (xvi) an end-blocker; (xvii) a reaction inhibitor; (xviii) a drying agent; (xix) a water release agent; (xx) a colorant; (xxi) an anti-aging additive; (xxii) a biocide; (xxiii) a flame retardant; (xxiv) a corrosion inhibitor; (xxv) a catalyst inhibitor; (xxvi) a UV absorber; (xxvii) an anti-oxidant; (xxviii) a light-stabilizer; (xxix) a catalyst, procatalyst, or catalyst generator; (xxx) an initiator; (xxxi) a photoacid generator; (xxxii) a heat stabilizer; or (xxxiii) a combination of (i)-(xxxii).

15. The curable composition of claim 1, wherein the curable composition is free from: (i) a carrier vehicle; (ii) a reaction catalyst or promotor; (iii) an adhesion promoter; (iv) an electrically conductive filler; (v) a bleed suppression agent; or (vi) any combination of (i)-(v), other than components (I), (II), and (III).

16. A cured product of the curable composition of claim 1.

17. The cured product of claim 16, wherein the cured product is further defined as a conductive adhesive, and wherein the conductive adhesive exhibits: (i) a volume resistivity of less than 0.012 Ohm-centimeter measured according to the Volume Resistivity Test Method; (ii) an adhesion strength of at least 0.4 MPa measured according to the Adhesion Strength Test Method; (iii) a bleed rate of less than 15 μm/min measured according to the Bleed Test Method; or (iv) any combination of (i)-(iii).

18. A method of forming a composite article comprising a conductive layer, said method comprising:
disposing a composition on a substrate; and
curing the composition, optionally via heating, to give the conductive layer on the substrate, thereby forming the composite article;
wherein the composition is the curable composition of claim 1.

19. A composite article formed according to the method of claim 18.

20. The composite article of claim 19, wherein the substrate comprises a component of a functional device, optionally wherein the functional device is: (i) an optical device; (ii) a photoelectric device; (iii) a photo mechanic device; (iv) a photomagnetic device; (v) an electrical or electronic device; (vi) an electro-optical device; (vii) a mechanical device; (viii) an electromechanical device including a micro-electromechanical system; (ix) a magnetic device; (x) a photo-electro-magnetic device; (xi) a mechanomagnetic device; (xii) a thermal device; (xiii) a thermo-mechanical device; (xiv) a thermo-optical device; (xv) a thermo-electric or thermo-electronic device; (xvi) a thermo-magnetic device; or (xvii) any combination of (i)-(xvi).
